(19) United States
(12) Patent Application Publication
(10) Pub. No.: US 2026/0205169 A1
(43) Pub. Date: Jul. 16, 2026

(54) MACHINE LEARNING BLOCKAGE MITIGATION

(71) Applicant: QUALCOMM Incorporated, San Diego, CA (US)

(72) Inventors: Vasanthan RAGHAVAN, West Windsor Township, NJ (US); Jung Ho RYU, Englewood Cliffs, NJ (US); Junyi LI, Greentown, PA (US)

(21) Appl. No.: 19/026,060

(22) Filed: Jan. 16, 2025

(51) Int. Cl. H04B 7/0456; H04B 7/08; H04L 41/16

(52) U.S. Cl. CPC H04B 7/0456; H04B 7/086; H04L 41/16

(57) ABSTRACT

Methods, systems, and devices for wireless communications are described. A user equipment (UE) may transmit first information that is indicative of a set of characteristics associated with a blockage of one or more antenna panels of the UE. The UE may further receive second information associated with mitigation of the blockage based on transmission of the first information. The second information may be indicative of one or more first sets of beam weights to be used at the one or more antenna panels of the UE. The UE may calculate one or more second sets of beam weights based on the one or more first sets of beam weights. The UE may communicate with a network entity in accordance with one or more second sets of beam weights derived from the one or more first sets of beam weights.

### INTRODUCTION

The following relates to wireless communications, including mitigation of hand blockages, body blockages, or blockages due to other objects in the environment.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include transmitting first information that is indicative of a set of characteristics associated with a blockage of one or more antenna panels of the UE, receiving second information associated with mitigation of the blockage based on transmission of the first information, the second information indicative of one or more first sets of beam weights to be used at the one or more antenna panels of the UE, and communicating in accordance with one or more second sets of beam weights derived from the one or more first sets of beam weights.

A UE for wireless communications is described. The UE may include one or more memories, and one or more processors coupled with the one or more memories. The one or more processors may be configured to cause the UE to transmit first information that is indicative of a set of characteristics associated with a blockage of one or more antenna panels of the UE, receive second information associated with mitigation of the blockage based on transmission of the first information, the second information indicative of one or more first sets of beam weights to be used at the one or more antenna panels of the UE, and communicate in accordance with one or more second sets of beam weights derived from the one or more first sets of beam weights.

Another UE for wireless communications is described. The UE may include means for transmitting first information that is indicative of a set of characteristics associated with a blockage of one or more antenna panels of the UE, means for receiving second information associated with mitigation of the blockage based on transmission of the first information, the second information indicative of one or more first sets of beam weights to be used at the one or more antenna panels of the UE, and means for communicating in accordance with one or more second sets of beam weights derived from the one or more first sets of beam weights.

A non-transitory computer-readable medium storing code for wireless communications is described. The code may include instructions executable by one or more processors to cause a UE to transmit first information that is indicative of a set of characteristics associated with a blockage of one or more antenna panels of the UE, receive second information associated with mitigation of the blockage based on transmission of the first information, the second information indicative of one or more first sets of beam weights to be used at the one or more antenna panels of the UE, and communicate in accordance with one or more second sets of beam weights derived from the one or more first sets of beam weights.

Some examples of the method, UEs, and non-transitory computer-readable medium described herein may further include operations, features, means, or instructions for transmitting, prior to transmission of the first information, third information to train a machine learning model at a network entity, the third information indicative of a second set of characteristics associated with a second blockage of the one or more antenna panels, where reception of the second information may be based on reception of an output of the machine learning model.

In some examples of the method, UEs, and non-transitory computer-readable medium described herein, the blockage may be associated with a hand blockage or a body blockage and the set of characteristics includes a grip strength of the hand blockage, a quantity of fingers that block the one or more antenna panels, a skin property of the hand blockage, a body tissue characteristic associated with the body blockage, or any combination thereof.

Some examples of the method, UEs, and non-transitory computer-readable medium described herein may further include operations, features, means, or instructions for obtaining the set of characteristics from one or more sensors associated with detection of the blockage at the one or more antenna panels, where the set of characteristics indicated via the first information may be based on data obtained from the one or more sensors.

In some examples of the method, UEs, and non-transitory computer-readable medium described herein, the first information includes an indication of one or more third sets of beam weights associated with mitigation of the blockage.

Some examples of the method, UEs, and non-transitory computer-readable medium described herein may further include operations, features, means, or instructions for receiving a control message including configuration information associated with one or more reporting occasions, where transmission of the first information occurs within the one or more reporting occasions based on the configuration information.

In some examples of the method, UEs, and non-transitory computer-readable medium described herein, the first information may be associated with input data for a machine learning model at a network entity and the second information may be associated with an output of the machine learning model that may be based on the input data.

In some examples of the method, UEs, and non-transitory computer-readable medium described herein, receiving the second information may include operations, features, means, or instructions for receiving a first index associated with a first set of beam weights of the one or more first sets of beam weights, where the first index may be one of a set of multiple indices that may be each associated with a respective set of beam weights of the one or more first sets of beam weights.

Some examples of the method, UEs, and non-transitory computer-readable medium described herein may further include operations, features, means, or instructions for transmitting, prior to reception of the second information, an indication of a requested quantity of beam weights, where a quantity of beam weights of the one or more first sets of beam weights may be based on the requested quantity.

Some examples of the method, UEs, and non-transitory computer-readable medium described herein may further include operations, features, means, or instructions for selecting the one or more second sets of beam weights from a set of multiple available beam weights, where the set of multiple available beam weights may be defined based on the one or more first sets of beam weights.

A method for wireless communications by a network entity is described. The method may include obtaining first information that is indicative of a set of characteristics associated with a blockage of one or more antenna panels of a UE, using a machine learning model to obtain second information based on the first information, outputting the second information based on usage of the machine learning model, the second information associated with mitigation of the blockage and indicative of one or more first sets of beam weights available to the UE, and communicating in accordance with one or more second sets of beam weights derived from the one or more first sets of beam weights.

A network entity for wireless communications is described. The network entity may include one or more memories, and one or more processors coupled with the one or more memories. The one or more processors may be configured to cause the network entity to obtain first information that is indicative of a set of characteristics associated with a blockage of one or more antenna panels of a UE, used a machine learning model to obtain second information based on the first information, output the second information based on usage of the machine learning model, the second information associated with mitigation of the blockage and indicative of one or more first sets of beam weights available to the UE, and communicate in accordance with one or more second sets of beam weights derived from the one or more first sets of beam weights.

Another network entity for wireless communications is described. The network entity may include means for obtaining first information that is indicative of a set of characteristics associated with a blockage of one or more antenna panels of a UE, means for using a machine learning model to obtain second information based on the first information, means for outputting the second information based on usage of the machine learning model, the second information associated with mitigation of the blockage and indicative of one or more first sets of beam weights available to the UE, and means for communicating in accordance with one or more second sets of beam weights derived from the one or more first sets of beam weights.

A non-transitory computer-readable medium storing code for wireless communications is described. The code may include instructions executable by one or more processors to cause a network entity to obtain first information that is indicative of a set of characteristics associated with a blockage of one or more antenna panels of a UE, used a machine learning model to obtain second information based on the first information, output the second information based on usage of the machine learning model, the second information associated with mitigation of the blockage and indicative of one or more first sets of beam weights available to the UE, and communicate in accordance with one or more second sets of beam weights derived from the one or more first sets of beam weights.

Some examples of the method, network entities, and non-transitory computer-readable medium described herein may further include operations, features, means, or instructions for obtaining, from one or more UEs prior to acquisition of the first information, third information to train the machine learning model, the third information indicative of a second set of characteristics associated with one or more second blockages of one or more second antenna panels of the one or more UEs, where usage of the machine learning model may be based on the third information.

In some examples of the method, network entities, and non-transitory computer-readable medium described herein, the blockage may be associated with a hand blockage or a body blockage and the set of characteristics includes a grip strength of the hand blockage, a quantity of fingers that block the one or more antenna panels, a skin property of the hand blockage, a body tissue characteristic associated with the body blockage, or any combination thereof.

In some examples of the method, network entities, and non-transitory computer-readable medium described herein, the set of characteristics may be associated with data from one or more sensors.

In some examples of the method, network entities, and non-transitory computer-readable medium described herein, the first information includes an indication of one or more third sets of beam weights associated with mitigation of the blockage.

Some examples of the method, network entities, and non-transitory computer-readable medium described herein may further include operations, features, means, or instructions for outputting a control message including configuration information associated with one or more reporting occasions, where acquisition of the first information occurs within the one or more reporting occasions based on the configuration information.

In some examples of the method, network entities, and non-transitory computer-readable medium described herein, the first information may be associated with input data for the machine learning model and the second information may be associated with an output that may be inferred based on use of the machine learning model in accordance with the input data.

In some examples of the method, network entities, and non-transitory computer-readable medium described herein, outputting the second information may include operations, features, means, or instructions for outputting a first index associated with a first set of beam weights including the one or more first sets of beam weights, where the first index may be one of a set of multiple indices that may be each associated with a respective set of beam weights of a set of multiple sets of beam weights.

Some examples of the method, network entities, and non-transitory computer-readable medium described herein may further include operations, features, means, or instructions for obtaining, prior to output of the second information, an indication of a requested quantity of beam weights, where a quantity of beam weights of the one or more first sets of beam weights may be based on the requested quantity.

In some examples of the method, network entities, and non-transitory computer-readable medium described herein, the one or more first sets of beam weights may be associated with a set of multiple beam weights available to one or more UEs.

A method for wireless communications by a UE is described. The method may include obtaining an indication of one or more first sets of beam weights associated with mitigation of a blockage of one or more antenna panels of the UE, calculating one or more second sets of beam weights to use for communications by the UE, the one or more second sets of beam weights based on a quantization of the one or more first sets of beam weights that satisfies one or more communication thresholds, and communicating in accordance with the one or more second sets of beam weights derived from the one or more first sets of beam weights.

A UE for wireless communications is described. The UE may include one or more memories, and one or more processors coupled with the one or more memories. The one or more processors may be configured to cause the UE to obtain an indication of one or more first sets of beam weights associated with mitigation of a blockage of one or more antenna panels of the UE, calculate one or more second sets of beam weights to use for communications by the UE, the one or more second sets of beam weights based on a quantization of the one or more first sets of beam weights that satisfies one or more communication thresholds, and communicate in accordance with the one or more second sets of beam weights derived from the one or more first sets of beam weights.

Another UE for wireless communications is described. The UE may include means for obtaining an indication of one or more first sets of beam weights associated with mitigation of a blockage of one or more antenna panels of the UE, means for calculating one or more second sets of beam weights to use for communications by the UE, the one or more second sets of beam weights based on a quantization of the one or more first sets of beam weights that satisfies one or more communication thresholds, and means for communicating in accordance with the one or more second sets of beam weights derived from the one or more first sets of beam weights.

A non-transitory computer-readable medium storing code for wireless communications is described. The code may include instructions executable by one or more processors to cause a UE to obtain an indication of one or more first sets of beam weights associated with mitigation of a blockage of one or more antenna panels of the UE, calculate one or more second sets of beam weights to use for communications by the UE, the one or more second sets of beam weights based on a quantization of the one or more first sets of beam weights that satisfies one or more communication thresholds, and communicate in accordance with the one or more second sets of beam weights derived from the one or more first sets of beam weights.

In some examples of the method, UEs, and non-transitory computer-readable medium described herein, calculating the one or more second sets of beam weights may include operations, features, means, or instructions for determining a linear combination of the one or more first sets of beam weights, the quantization of the one or more first sets of beam weights based on the linear combination.

In some examples of the method, UEs, and non-transitory computer-readable medium described herein, obtaining the one or more first sets of beam weights may include operations, features, means, or instructions for obtaining one or more third sets of beam weights that may be inferred based on a machine learning model and selecting the one or more first sets of beam weights from a set of multiple available beam weights, where the set of multiple available beam weights may be defined based on the one or more third sets of beam weights.

Some examples of the method, UEs, and non-transitory computer-readable medium described herein may further include operations, features, means, or instructions for transmitting first information that may be indicative of a set of characteristics associated with the blockage, the first information associated with input data for a machine learning model at a network entity, where the one or more first sets of beam weights may be obtained based on second information received from an output of the machine learning model that may be based on the input data.

In some examples of the method, UEs, and non-transitory computer-readable medium described herein, the one or more communication thresholds include one or more phase shift thresholds, one or more amplitude thresholds, or both.

In some examples of the method, UEs, and non-transitory computer-readable medium described herein, the one or more second sets of beam weights may be different than the one or more first sets of beam weights.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports machine learning (ML) blockage mitigation in accordance with one or more aspects of the present disclosure.

FIG. 2 shows an example of a network architecture that supports ML blockage mitigation in accordance with one or more aspects of the present disclosure.

FIG. 3 shows an example of an ML model represented by an artificial neural network (ANN) that supports ML blockage mitigation in accordance with one or more aspects of the present disclosure.

FIG. 4 shows an example of a wireless communications system that supports ML blockage mitigation in accordance with one or more aspects of the present disclosure.

FIGS. 5 and 6 show examples of process flows that support ML blockage mitigation in accordance with one or more aspects of the present disclosure.

FIG. 7 shows an example of a timing diagram that supports ML blockage mitigation in accordance with one or more aspects of the present disclosure.

FIG. 8 shows an example of a beam weight dictionary that supports ML blockage mitigation in accordance with one or more aspects of the present disclosure.

FIGS. 9 and 10 show block diagrams of devices that support ML blockage mitigation in accordance with one or more aspects of the present disclosure.

FIG. 11 shows a block diagram of a communications manager that supports ML blockage mitigation in accordance with one or more aspects of the present disclosure.

FIG. 12 shows a diagram of a system including a device that supports ML blockage mitigation in accordance with one or more aspects of the present disclosure.

FIGS. 13 and 14 show block diagrams of devices that support ML blockage mitigation in accordance with one or more aspects of the present disclosure.

FIG. 15 shows a block diagram of a communications manager that supports ML blockage mitigation in accordance with one or more aspects of the present disclosure.

FIG. 16 shows a diagram of a system including a device that supports ML blockage mitigation in accordance with one or more aspects of the present disclosure.

FIGS. 17 through 22 show flowcharts illustrating methods that support ML blockage mitigation in accordance with one or more aspects of the present disclosure.

### DETAILED DESCRIPTION

In some wireless communication systems, a user equipment (UE) may include one or more antenna panels to perform wireless communications (e.g., to receive, obtain, transmit, output, or otherwise utilize wireless signaling techniques). An “antenna panel” may refer to an array of antenna elements, which may be used to communicate (e.g., transmit or receive) radio frequency signals with other devices (e.g., network entities, UEs). In some cases, one or more antenna panels of the UE may become blocked (e.g., due to various obstructions), which may reduce communication performance of the one or more antenna panels. A “blockage” may refer to any item that impedes, obstructs, or otherwise interferes with a signal pathway between an antenna panel used for transmission or reception and a corresponding receiver or transmitter. Examples of such blockages may include a body of a user (e.g., a hand blockage, a body blockage due to different body parts, or some other user blockage), environmental blockages (e.g., buildings, walls, vehicles), or system components (e.g., coverings, casings, or other UE components). These blockages may reduce communication quality for a UE by inhibiting reception and transmission of wireless communication signals (e.g., introducing losses of 5 decibels (dB) or more in some cases). Some methods for blockage mitigation at the UE may be constrained due to limited processing resources and other factors. Such limitations may be addressed by applying one or more techniques described herein.

In accordance with one or more aspects of the present disclosure, one or more network entities may assist one or more UEs with blockage mitigation by receiving feedback information from the one or more UEs. “Blockage mitigation” may refer to one or more operations that attempt to reduce or limit attenuation of wireless signal (e.g., reduce losses in signal amplitude) caused by a blockage. In some examples, an artificial intelligence (AI) model or a machine learning (ML) model (e.g., implemented at a network entity) may assist with (e.g., improve) blockage mitigation by outputting (e.g., generating, inferring, identifying) one or more sets of beam weights available to a UE for mitigation of the blockage based on input data (e.g., received by the network entity) from the UE. The output or inferred beam weight sets may have a relatively higher probability of successful blockage mitigation at the UE (e.g., by identifying an optimal set of beam weights). A “beam weight” may refer to one or more factors (e.g., coefficients) applied to a signal that is transmitted or received by each antenna element in an antenna array (e.g., and may control a phase and an amplitude of the signal). A combination of one or more beam weights may effectively steer a transmission in a specific direction by adjusting the amplitude and/or phase of various beams.

In some examples, a UE may be configured to transmit blockage feedback information and beam weight information to a network entity to support AI/ML assisted blockage mitigation techniques. The blockage feedback information may include various characteristics associated with a blockage. A “characteristic” may refer to a feature or property that influences how the blockage affects the signal transmission and reception. Example characteristics may include a strength of a hand grip, a quantity of fingers that block an antenna panel, one or more properties of the blockage such as skin properties, density properties, reflective properties, other physical properties, or some other detectable characteristic of the blockage. In some examples, the beam weight information may include an indication of one or more beam weights the UE uses for communication (e.g., one or more sets of beam weights available to the UE).

The UE may mitigate signal attenuation caused by the blockage by utilizing a given combination of beam weights or beam weight sets that minimize the signal attenuation in the presence of the blockage. In other words, the combination of beam weights or beam weight sets results in a beam directionality, amplitude, and phase that is less subject to (or minimizes) the signal attenuation due to the blockage. As such, the network entity may use the feedback and beam weight information to train (e.g., or refine) the AI/ML model to output one or more predicted beam weight sets that the UE may use to mitigate the blockage. Additionally, or alternatively, the network entity may use the feedback and beam weight information as input data to the AI/ML model (e.g., a trained model) and may obtain, from the output of the AI/ML model, one or more sets of predicted beam weights for blockage mitigation, which the network entity may output (e.g., transmit, indicate) to the UE. The predicted beam weight sets may be a combination of beam weights that, when utilized by the UE, result in a relatively low (e.g., a lowest, a minimized) signal attenuation caused by the blockage. The UE may utilize the predicted beam weight sets to determine (e.g., calculate, select) one or more actual beam weights to use for communications with the network entity, which may result in improved (e.g., optimized) blockage mitigation.

In some examples, by providing the blockage feedback information and beam weight information to the network entity (e.g., for AI/ML model training, to obtain predicted beam weights), the network entity may provide relatively higher quality information (e.g., more accurate beam weight suggestions), thus increasing system performance by reducing processing overhead at the UE and enabling optimized beam weigh selections. Additionally, by training an AI/ML server using the blockage characteristics, the network entity may more efficiently and accurately determine beam weights to mitigate blockages, which may reduce overall power consumption and increase communication reliability between devices. Moreover, by using the AI/ML model to output one or more sets of beam weights, the UE may be enabled to improve blockage mitigation based on the predicted beam weight sets obtained from the AI/ML model by the network entity and transmitted to the UE. As such, the UE may more effectively reduce the adverse effects of common antenna panel blockages. Further, by using the beam weight information outputted by the AI/ML model, the UE may support flexible techniques for blockage mitigation, which may increase communication reliability and improve overall user experience.

Aspects of the disclosure are initially described in the context of wireless communications systems. Aspects of the disclosure are further illustrated by and described with reference to ANNs, process flows, apparatus diagrams, system diagrams, and flowcharts that relate to machine learning blockage mitigation.

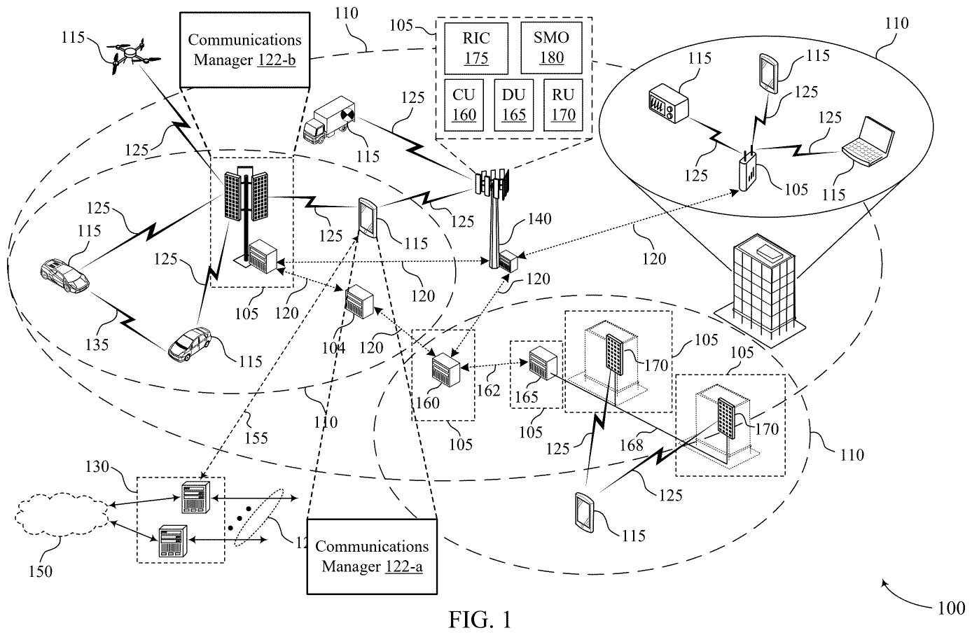

FIG. 1 shows an example of a wireless communications system 100 that supports machine learning blockage mitigation in accordance with one or more aspects of the present disclosure. The wireless communications system 100 may include one or more devices, such as one or more network devices (e.g., network entities 105), one or more UEs 115, and a core network 130. In some examples, the wireless communications system 100 may be an LTE network, an LTE-A network, an LTE-A Pro network, an NR network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

As described herein, a node, which may be referred to as a node, a network node, a network entity, or a wireless node, may be a base station (e.g., any base station described herein), a UE (e.g., any UE described herein), a network controller, an apparatus, a device, a computing system, one or more components, and/or another suitable processing entity configured to perform any of the techniques described herein. For example, a network node may be a UE. As another example, a network node may be a base station. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE being configured to receive information from a base station also discloses that a first network node being configured to receive information from a second network node, the first network node may refer to a first UE, a first base station, a first apparatus, a first device, a first computing system, a first one or more components, a first processing entity, or the like configured to receive the information; and the second network node may refer to a second UE, a second base station, a second apparatus, a second device, a second computing system, a second one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support machine learning blockage mitigation as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or DFT-S-OFDM. In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or analog beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some cases, a UE 115 may include one or more antenna panels to perform wireless communications (e.g., to receive, obtain, transmit, output, or otherwise utilize wireless signaling techniques). In some cases, one or more blockages (e.g., hand blockages, body blockages, buildings, walls, vehicles, or other physical obstructions) may obstruct one or more antenna panels of the UE 115. Such blockages may significantly reduce communication quality in the wireless communications system 100. Some methods for mitigation of blockages may include UE-based adjustments (e.g., such as beam switching or adaptive beam weight selection), or the UE 115 may not mitigate the blockage (e.g., an accept the associated losses). However, UE-based adjustments may be limited in terms of processing resources and channel condition information, resulting in inefficiencies in the wireless communications system 100.

In accordance with one or more aspects described herein, one or more network entities 105 may assist one or more UEs 115 with antenna panel blockage mitigation. In some examples, a UE 115 may include a communications manager 122-a and a network entity 105 may include a communications manager 122-b, which may enable the respective devices to perform one or more techniques described herein. In some examples, a network entity 105 may (e.g., via or in accordance with the communications manager 122-b) utilize (e.g., may include, may communicate with) an AI/ML server to improve blockage mitigation by outputting one or more sets beam weights available to the UE 115 for mitigation of the blockage. In some examples, one or more UEs 115 may (e.g., via or in accordance with the communications manager 122-a) be configured to transmit first information indicative of various blockage characteristics or selected beam weights as input data or as training data for an AI/ML model at the network entity 105. The network entity 105 may use the first information to train the AI/ML model and/or to obtain second information indicative of one or more inferred sets of beam weights for blockage mitigation, and may output the second information to the UE 115. In some examples, the UE 115 may utilize the second information received from the network entity 105 to calculate one or more second sets of beam weights to use for blockage mitigation during communications with the network entity 105. Thus, by applying one or more techniques herein, the wireless communications system 100 may be associated with improved coverage and improved communication reliability, among other performance enhancements.

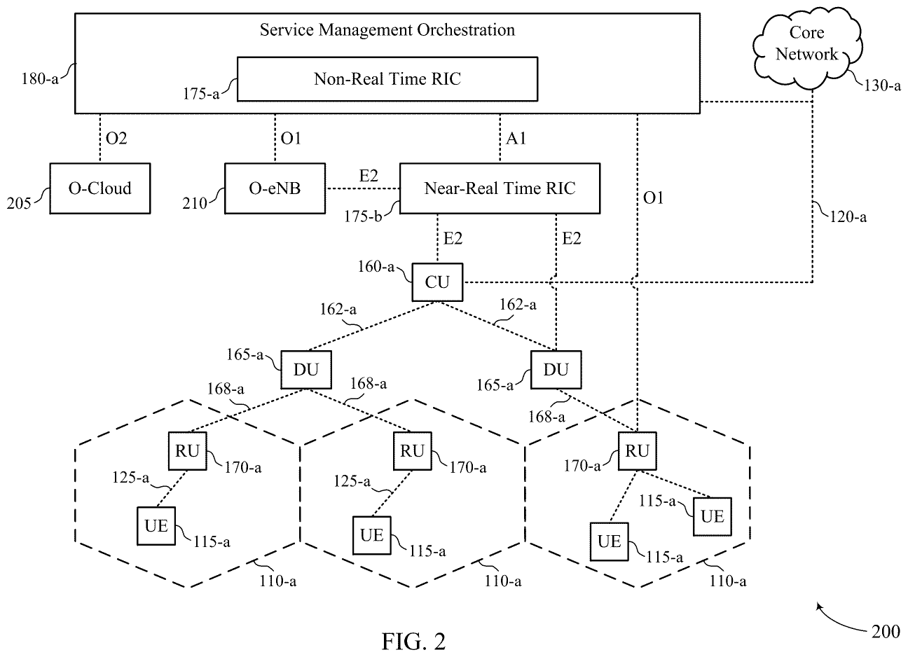

FIG. 2 shows an example of a network architecture 200 (e.g., a disaggregated base station architecture, a disaggregated RAN architecture) that supports machine learning blockage mitigation in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, AI or ML workflows including model training and updates, or policy-based guidance of applications/features in the Near-RT RIC 175-b. The Non-RT RIC 175-a may be coupled to or communicate with (e.g., via an AI interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via O1) or via generation of RAN management policies (e.g., A1 policies).

In various examples described herein, the network architecture 200 may support network assistance (e.g., via a network node, a CU 160, DU 165) of antenna panel blockage mitigation at one or more UEs 115. In some examples, a network entity 105 may utilize (e.g., may include, may communicate with) an AI/ML server to improve blockage mitigation by outputting one or more sets beam weights available to the UE 115 for mitigation of the blockage. In some examples, a UE 115 may be configured to transmit first information indicative of various blockage characteristics or selected beam weights as input data or as training data for an AI/ML model at the network entity 105. The network entity 105 may use the first information to train the AI/ML model and/or to obtain second information indicative of one or more first sets of beam weights for blockage mitigation, and may output the second information to the UE 115. In some examples, the UE 115 may utilize the second information received from the network entity 105 to calculate one or more second sets of beam weights to use for blockage mitigation during communications with the network entity 105. Thus, by utilizing one or more techniques herein, the network architecture 200 may enable improved coverage and improved communication reliability in various wireless communications systems.

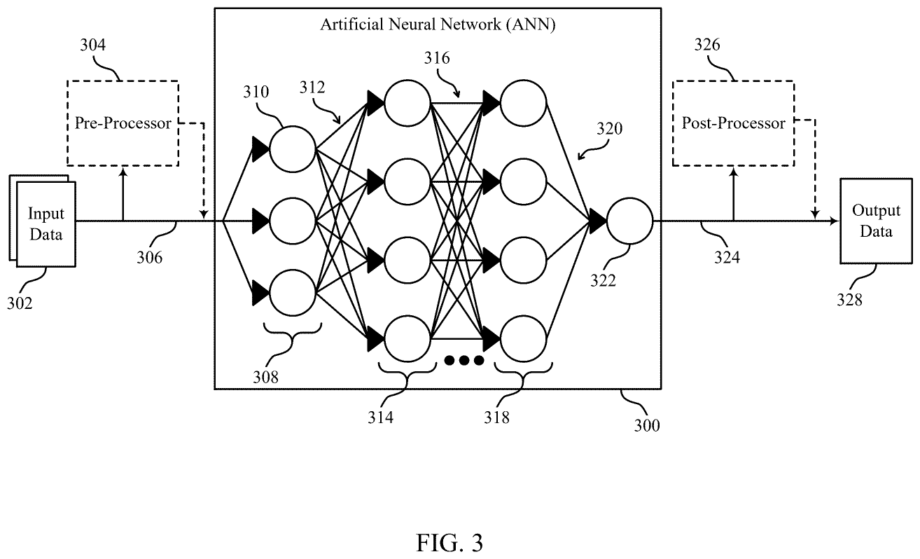

FIG. 3 is an illustrative block diagram of an example ML model represented by an artificial neural network (ANN) 300 that supports machine learning blockage mitigation in accordance with one or more aspects of the present disclosure.

ANN 300 may receive input data 306 which may include one or more bits of data 302, pre-processed data output from pre-processor 304 (optional), or some combination thereof. Here, data 302 may include training data, verification data, application-related data, or the like, based, for example, on the stage of deployment of ANN 300. Pre-processor 304 may be included within ANN 300 in some other implementations. Pre-processor 304 may, for example, process all or a portion of data 302 which may result in some of data 302 being changed, replaced, deleted, etc. In some implementations, pre-processor 304 may add additional data to data 302. In some implementations, the pre-processor 304 may be an ML model, such as an ANN.

ANN 300 includes at least one first layer 308 of artificial neurons 310 to process input data 306 and provide resulting first layer data via connections or “edges” such as edges 312 to at least a portion of at least one second layer 314. Second layer 314 processes data received via edges 312 and provides second layer output data via edges 316 to at least a portion of at least one third layer 318. Third layer 318 processes data received via edges 316 and provides third layer output data via edges 320 to at least a portion of a final layer 322 including one or more neurons to provide output data 324. All or part of output data 324 may be further processed in some manner by (optional) post-processor 326. Thus, in certain examples, ANN 300 may provide output data 328 that is based on output data 324, post-processed data output from post-processor 326, or some combination thereof.

Post-processor 326 may be included within ANN 300 in some other implementations. Post-processor 326 may, for example, process all or a portion of output data 324 which may result in output data 328 being different, at least in part, to output data 324, as result of data being changed, replaced, deleted, etc. In some implementations, post-processor 326 may be configured to add additional data to output data 324. In this example, second layer 314 and third layer 318 represent intermediate or hidden layers that may be arranged in a hierarchical or other like structure. Although not explicitly shown, there may be one or more further intermediate layers between the second layer 314 and the third layer 318. In some implementations, the post-processor 326 may be an ML model, such as an ANN.

The structure and training of artificial neurons 310 in the various layers may be tailored to specific requirements of an application. Within a given layer such as first layer 308, second layer 314, or third layer 318 of ANN 300, some or all of the neurons may be configured to process information provided to the layer and output corresponding transformed information from the layer. For example, transformed information from a layer may represent a weighted sum of the input information associated with or otherwise based on a non-linear activation function or other activation function used to “activate” artificial neurons of a next layer. Artificial neurons in such a layer may be activated by or be responsive to parameters such as the previously described weights and biases of ANN 300. The weights and biases of ANN 300 may be adjusted during a training process or during operation of ANN 300. The weights of the various artificial neurons may control a strength of connections between layers or artificial neurons, while the biases may control a direction of connections between the layers or artificial neurons. An activation function may select or determine whether an artificial neuron transmits its output to the next layer or not in response to its received data.

Different activation functions may be used to model different types of non-linear relationships. By introducing non-linearity into an ML model, an activation function allows the configuration for the ML model to change in response to identifying or detecting complex patterns and relationships in the input data 306. Some non-exhaustive example activation functions include a sigmoid based activation function, a hyperbolic tangent (tanh) based activation function, a convolutional activation function, up-sampling, pooling, and a rectified linear unit (ReLU) based activation function.

Training of an ML model, such as ANN 300, may be conducted using training data. Training data may include one or more datasets which ANN 300 may use to identify patterns or relationships. Training data may represent various types of information, including written, visual, audio, environmental context, operational properties, etc. During training, the parameters (such as the weights and biases) of artificial neurons 310 may be changed, such as to minimize or otherwise reduce a loss function or a cost function. A training process may be repeated multiple times to fine-tune ANN 300 with each iteration.

Various ANN model structures are available for consideration. For example, in a feedforward ANN structure, each artificial neuron 310 in layer 314 receives information from the previous layer (such as, one or more artificial neurons 310 in layer 308) and produces information for the next layer (such as, one or more artificial neurons 310 in layer 318). In a convolutional ANN structure, some layers may be organized into filters that extract features from data, such as the training data or the input data. In a recurrent ANN structure, some layers may have connections that allow for processing of data across time, such as for processing information having a temporal structure, such as time series data forecasting.

In an autoencoder ANN structure, compact representations of data may be processed and the model trained to predict or potentially reconstruct original data from a reduced set of features. An autoencoder ANN structure may be useful for tasks related to dimensionality reduction and data compression.

A generative adversarial ANN structure may include a generator ANN and a discriminator ANN that are trained to compete with each other. Generative-adversarial networks (GANs) are ANN structures that may be useful for tasks relating to generating synthetic data or improving the performance of other models.

A transformer ANN structure makes use of attention mechanisms that may enable the model to process input sequences in a parallel and efficient manner. An attention mechanism allows the model to focus on different parts of the input sequence at different times. Attention mechanisms may be implemented using a series of layers known as attention layers to compute weighted sums of input features based on a similarity between different elements of the input sequence. A transformer ANN structure may include a series of feedforward ANN layers whose configurations may change in response to identifying non-linear relationships between the input and output sequences, which may also be referred to as a process of “learning” by the ANN layers. The output of a transformer ANN structure may be obtained by applying a linear transformation to the output of a final attention layer. A transformer ANN structure may be of particular use for tasks that involve sequence modeling, or other like processing.

Another example type of ANN structure is a model with one or more invertible layers. Models of this type may be inverted or “unwrapped” to reveal the input data that was used to generate the output of a layer. Other example types of ANN model structures include fully connected neural networks (FCNNs) and long short-term memory (LSTM) networks.

ANN 300 or other ML models may be implemented in various types of processing circuits along with memory and applicable instructions therein. For example, general-purpose hardware circuits, such as, such as one or more central processing units (CPUs), one or more graphics processing units (GPUs), or suitable combinations thereof, may be employed to implement a model. In some implementations, one or more tensor processing units (TPUs), neural processing units (NPUs), or other special-purpose processors, field-programmable gate arrays (FPGAs), application-specific integrated circuits (ASICs), or the like may also be employed. In some implementations, the ML model may be implemented by a NPU or a TPU embedded in a system on chip (SoC) along with other components, such as one or more CPUs, GPUs, etc. A SoC includes several components manufactured on a shared semiconductor substrate. The NPU or TPU may be controlled by the one or more CPUs by configuring the ML model implemented by the NPU or TPU with weights and biases, providing certain training data to the ML model to configure the ML model, or providing input data to the ML model to obtain related inferences. The one or more CPUs may also receive the inferences and be configured to perform certain actions based on the inferences produced by the ML model. The actions performed by the one or more CPUs may include sending commands to other components of the SoC or components external to the SoC to perform certain actions. For example, the CPU may send commands to a RF transceiver based on the outputs or inferences obtained from an ML model to cause the RF transceiver to operate on a wireless network in accordance with the ML model.

In example aspects, an ML model may be trained prior to, or at some point following, operation of the ML model, such as ANN 300, on input data. When training the ML model, information in the form of applicable training data may be gathered or otherwise created for use in training an ANN accordingly. For example, training data may be gathered or otherwise created regarding information associated with received/transmitted signal strengths, interference, and resource usage data, as well as any other relevant data that might be useful for training a model to address one or more problems or issues in a communication system. In certain instances, all or part of the training data may originate in a UE or other device in a wireless communication system, or one or more network entities, or aggregated from multiple sources (such as a UE and a network entity/entities, one or more other UEs, the Internet, or the like). For example, wireless network architectures, such as self-organizing networks (SON) or mobile drive test (MDT) networks, may be adapted to support collection of data for ML model applications. In another example, training data may be generated or collected online, offline, or both online and offline by one or more UEs, network entity, or other device(s), and all or part of such training data may be transferred or shared (in real or near-real time), such as through store and forward functions or the like.

Offline training may refer to creating and using a static training dataset, such as, in a batched manner, whereas online training may refer to a real-time collection and use of training data. For example, an ML model at a network device (such as, a UE) may be trained or fine-tuned using online or offline training. For offline training, data collection and training can occur in an offline manner at the network side (such as, at a base station or other network entity) or at the UE side. For online training, the training of a UE-side ML model may be performed locally at the UE or by a server device (such as, a server hosted by a UE vendor) in a real-time or near-real-time manner based on data provided to the server device from the UE. In certain instances, all or part of the training data may be shared within in a wireless communication system, or even shared (or obtained from) outside of the wireless communication system.

Once an ANN has been configured by setting parameters, including weights and biases, from training data, the ANN's performance may be evaluated. In some scenarios, evaluation/verification tests may use a validation dataset, which may include data not in the training data, to compare the model's performance to baseline or other benchmark information. The ANN configuration may be further refined, for example, by changing its architecture, re-training it on the data, or using different optimization techniques, etc.

As part of a training process, parameters affecting the functioning of the artificial neurons and layers may be adjusted. For example, backpropagation techniques may be used to train an ANN by iteratively adjusting weights or biases of certain artificial neurons associated with errors between a predicted output of the model and a desired output that may be known or otherwise deemed acceptable. Backpropagation may include a forward pass, a loss function, a backward pass, and a parameter update that may be performed in training iteration. The process may be repeated for a certain number of iterations for each set of training data until the weights of the artificial neurons/layers are adequately tuned.

Backpropagation techniques associated with a loss function may measure how well a model is able to predict a desired output for a given input. An optimization algorithm may be used during a training process to adjust weights and biases as needed to reduce or minimize the loss function which should improve the performance of the model. There are a variety of optimization algorithms that may be used along with backpropagation techniques or other training techniques. Some initial examples include a gradient descent based optimization algorithm and a stochastic gradient descent based optimization algorithm. A stochastic gradient descent technique may be used to adjust weights/biases in order to minimize or otherwise reduce a loss function. A mini-batch gradient descent technique, which is a variant of gradient descent, may involve updating weights/biases using a small batch of training data rather than the entire dataset. A momentum technique may accelerate an optimization process by adding a momentum term to update or otherwise affect certain weights/biases.

An adaptive learning rate technique may adjust a learning rate of an optimization algorithm associated with one or more characteristics of the training data. A batch normalization technique may be used to normalize inputs to a model in order to stabilize a training process and potentially improve the performance of the model. A “dropout” technique may be used to randomly drop out some of the artificial neurons from a model during a training process, for example, in order to reduce overfitting and potentially improve the generalization of the model. An “early stopping” technique may be used to stop an on-going training process early, such as when a performance of the model using a validation dataset starts to degrade.

Another example technique includes data augmentation to generate additional training data by applying transformations to all or part of the training information. A transfer learning technique may be used which involves using a pre-trained model as a starting point for training a new model, which may be useful when training data is limited or when there are multiple tasks that are related to each other. A multi-task learning technique may be used which involves training a model to perform multiple tasks simultaneously to potentially improve the performance of the model on one or more of the tasks. Hyperparameters or the like may be input and applied during a training process in certain instances.

Another example technique that may be useful with regard to an ANN is a “pruning” technique. A pruning technique, which may be performed during a training process or after a model has been trained, involves the removal of unnecessary or less necessary, or possibly redundant features from a model. In certain instances, a pruning technique may reduce the complexity of a model or improve efficiency of a model without undermining the intended performance of the model.

Pruning techniques may be particularly useful in the context of wireless communication, where the available resources (such as power and bandwidth) may be limited. Some example pruning techniques include a weight pruning technique, a neuron pruning technique, a layer pruning technique, a structural pruning technique, and a dynamic pruning technique. Pruning techniques may, for example, reduce the amount of data corresponding to a model that may need to be transmitted or stored. Weight pruning techniques may involve removing some of the weights from a model. Neuron pruning techniques may involve removing some neurons from a model. Layer pruning techniques may involve removing some layers from a model. Structural pruning techniques may involve removing some connections between neurons in a model. Dynamic pruning techniques may involve adapting a pruning strategy of a model associated with one or more characteristics of the data or the environment. For example, in certain wireless communication devices, a dynamic pruning technique may more aggressively prune a model for use in a low-power or low-bandwidth environment, and less aggressively prune the model for use in a high-power or high-bandwidth environment. In certain example implementations, pruning techniques also may be applied to training data, for example, to remove outliers. In some implementations, pre-processing techniques directed to all or part of a training dataset may improve model performance or promote faster convergence of a model. For example, training data may be pre-processed to change or remove unnecessary data, extraneous data, incorrect data, or otherwise identifiable data. Such pre-processed training data may, for example, lead to a reduction in potential overfitting, or otherwise improve the performance of the trained model.

One or more of the example training techniques presented above may be employed as part of a training process. Some example training processes that may be used to train an ANN include supervised learning, unsupervised learning, semi-supervised learning, and reinforcement learning technique. With supervised learning, a model is trained on a labeled training dataset, wherein the input data is accompanied by a correct or otherwise acceptable output. With unsupervised learning, a model is trained on an unlabeled training dataset, such that the model will need to learn to identify patterns and relationships in the data without the explicit guidance of a labeled training dataset. With semi-supervised learning, a model is trained using some combination of supervised and unsupervised learning processes, for example, when the amount of labeled data is somewhat limited. With reinforcement learning, a model may learn from interactions with its operation/environment, such as in the form of feedback akin to rewards or penalties. Reinforcement learning may be particularly beneficial when used to improve or attempt to optimize a behavior of a model deployed in a dynamically changing environment, such as a wireless communication network.

Distributed, shared, or collaborative learning techniques may be used for the training process. For example, techniques such as federated learning may be used to decentralize the training process and rely on multiple devices, network entities, or organizations for training various versions or copies of an ML model, without relying on a centralized training mechanism. Federated learning may be particularly useful in scenarios where data is sensitive or subject to privacy constraints, or where it is impractical, inefficient, or expensive to centralize data. In the context of wireless communication, for example, federated learning may be used to improve performance by allowing an ANN to be trained on data collected from a wide range of devices and environments. For example, an ANN may be trained on data collected from a large number of wireless devices in a network, such as distributed wireless communication nodes, smartphones, or IoT devices, to improve the network's performance and efficiency. With federated learning, a UE or other device may receive a copy of all or part of a global or shared model and perform local training on the local model using locally available training data. The UE may provide update information regarding the locally trained model to one or more other devices (such as a network entity or a server) where the updates from other-like devices (such as other UEs) may be aggregated and used to provide an update to global or shared model. A federated learning process may be repeated iteratively until all or part of a model obtains a satisfactory level of performance. Federated learning may enable devices to protect the privacy and security of local data, while supporting collaboration regarding training and updating of all or part of a shared model.

In some implementations, one or more devices or services may support processes relating to an ML model's usage, maintenance, activation, reporting, or the like. In certain instances, all or part of a dataset or model may be shared across multiple devices, to provide or otherwise augment or improve processing. In some examples, signaling mechanisms may be utilized at various nodes of wireless network to signal the capabilities for performing specific functions related to ML model, support for specific ML models, capabilities for gathering, creating, transmitting training data, or other ML related capabilities. ML models in wireless communication systems may, for example, be employed to support decisions or improve performance relating to wireless resource allocation or selection, wireless channel condition estimation, interference mitigation, beam management, positioning accuracy, energy savings, or modulation or coding schemes, etc. In some implementations, model deployment may occur jointly or separately at various network levels, such as, a UE, a network entity such as a base station, or a disaggregated network entity such as a CU, a DU, an RU, or the like.

As described herein, a network entity 105 may communicate with (e.g., include) an AI/ML server, which may implement one or more aspects of the ANN 300. For example, the ANN 300 may be used to improve blockage mitigation by outputting one or more sets beam weights available to a UE 115 for mitigation antenna panel blockages. In some examples, a UE 115 may be configured to transmit first information indicative of various characteristics associated with a blockage, or of one or more beam weights used by the UE 115. The first information may be used to train the ANN 300 or may be used as input data by the ANN 300 to obtain an output (e.g., second information, predicted sets of beam weights). Based on training the ANN 300 with first information received from one or more UEs 115, and AI/ML may be enabled to assist UEs 115 with blockage mitigation on demand. That is, a UE 115 may detect a blockage, transmit one or more characteristics associated with the blockage to the AI/ML server, and receive one or more beam weights that enable the UE to effectively mitigate the blockage. Thus, by utilizing one or more techniques herein, the ANN 300 may enable improved coverage, improved communication reliability, and other performance enhancements for a wireless communication system.

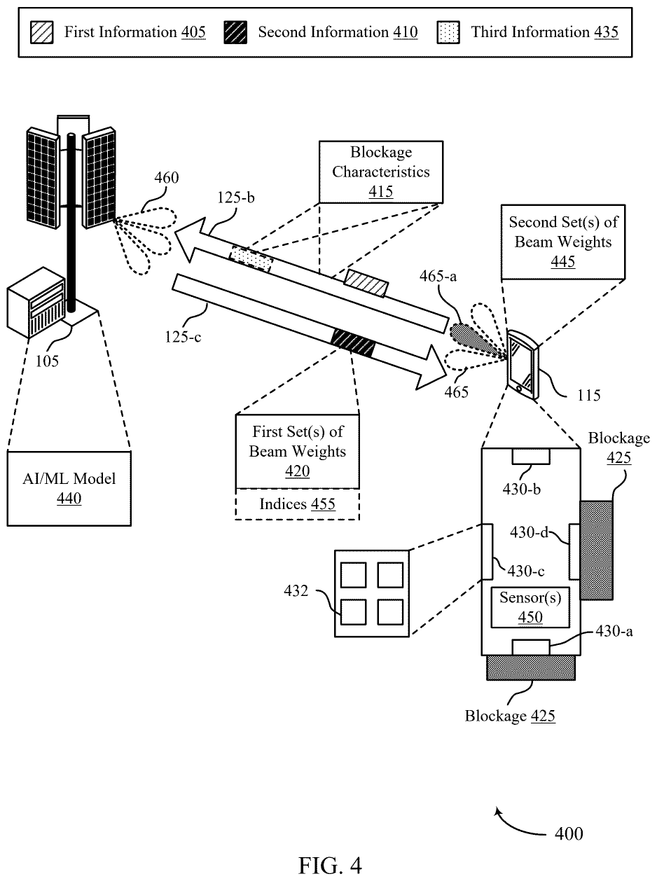

FIG. 4 shows an example of a wireless communications system 400 that supports machine learning blockage mitigation in accordance with one or more aspects of the present disclosure. The wireless communications system 400 may implement or be implemented by aspects of the wireless communications system 100, the network architecture 200, or the ANN 300 as described with reference to FIGS. 1 through 3. For example, the wireless communications system 400 may include a UE 115 and a network entity 105 (e.g., which may be examples of devices as described with reference to FIG. 1).

The network entity 105 may communicate with the UE 115 via one or more links 125. In some examples, the network entity 105 may use one or more beams 460 for communications with the UE 115, and the UE 115 may use one or more beams 465 for communications with the network entity 105. As described herein, the UE 115 may transmit (e.g., output, convey) first information 405, third information, or other signaling via a link 125-b (e.g., an uplink communication link) and may receive (e.g., obtain acquire) second information 410 or other signaling via a link 125-c (e.g., a downlink communication link). Although a network entity 105 and a UE 115 are shown as example devices of the wireless communications system 400, the techniques herein may be applied by one or more other devices described herein, including with reference to FIG. 1 through 3. Additionally, the described techniques may be applied by a greater quantity of devices than shown (e.g., two or more network entities 105, two or more UEs 115).

In some cases, a UE 115 may include one or more antenna panels 430 (e.g., multi-antenna modules, antenna components, antenna arrays including one or more antenna elements 432), which may be used to increase coverage, increase communication diversity, improve a link budget (e.g., at millimeter wave frequencies), and provide other benefits. Although an example configuration of antenna panels 430 is shown (e.g., with antenna panels 430-a through 430-d), the UE 115 may support other configurations of antenna panels 430, including with greater or fewer antenna panels 430 and with antenna panels 430 at different physical locations in the UE 115 than shown. The antenna panels 430 may frequently be subject to one or more blockages 425 (e.g., a hand blockage, buildings, walls, trees, vehicles, vehicle components, coverings, casings, other UE components, or some other physical object that impedes a line-of-sight between the antenna panel 430 and the network entity 105).

For example, a user may grip the UE 115 with a hand, which may present a blockage 425 at an antenna panel 430-a and an antenna panel 430-d. Due to an aperture of the one or more antenna panels 430, a size of a hand or fingers (e.g., associated with the blockage 425), and a carrier frequency, the blockage 425 may significantly impair communications by the UE 115. It may be noted that various blockage configurations may be possible at the UE 115. For example, one or more blockages 425 may be present at one or more of the antenna panels 430 (e.g., an antenna panel 430-c, an antenna panel 430-b) in any configuration (e.g., based on different grips of the UE 115 and/or orientations of the UE 115). In some cases, the blockage 425 (e.g., a hand blockage) may lead to a performance reduction (e.g., by up to 30 dB or more) depending on one or more characteristics of blockage 425. In a hand blockage example, such characteristics may include an air gap between fingers, an anatomy of the hand (e.g., a gender, a hand size, one or more skin properties of the hand, among other examples), a location of the antenna panel 430, and other factors.

The UE 115 may utilize various approaches to mitigate a blockage 425. For instance, the UE 115 may utilize module switching (e.g., when multiple antenna panels 430 are used at the UE 115) in which the UE may select different antenna panel 430 based on (e.g., to avoid) the blockage(s) 425. Additionally, or alternatively, the UE 115 (e.g., and/or the network entity 105) may utilize beam switching methods (e.g., at both a gNB and a UE 115, assuming improved paths are available at each device), which may include a use of adaptive and/or dynamic beam weights. The UE 115 and the network entity 105 may utilize one or more beam weights or beam weight sets to select one or more beams 465 and beams 460 to perform communications. The blockage(s) 425 may reduce communication quality in at least some of the beams 465. For example, a blockage 425 may cause relatively high signal attenuation in a beam 465-a. In some examples, the UE 115 may not actively mitigate the blockage(s) 425, and the UE 115 may continue to operate with the performance loss (e.g., which may be between 2 and 20 dB, depending on an angle of an antenna cluster relative to hand orientation and properties).

In cases of module switching (e.g., or beam switching), the UE 115 may switch antenna panels 430 (e.g., or beams in a same antenna panel 430 or different antenna panel 430) used for performing communications. The module switching may be performed within a same transmission reception point (TRP) or may be switched to a different TRP (e.g., via a handover mechanism in scenarios of a densified network with multiple TRPs). Module switching may be effective when a wireless channel has a relatively high channel quality. However, module switching may have reduced effectiveness in relatively low channel quality scenarios. Further, based on a configuration of antenna panels 430 and the location of the blockage(s) 425, module switching may not be able to achieve an unblocked state (e.g., an unblocked antenna cluster). Moreover, beam switching may be used when beam switching latencies are small relative to time-scales at which data disruption are acceptable (e.g., associated with a relatively low time overhead) or at time-scales at which channel or cluster properties change, which may be dependent on UE mobility. Thus, module switching and beam switching methods may be associated with increased overhead (e.g., on a control channel) and may not be suitable for at least some scenarios.

Additionally, in cases where the UE 115 uses adaptive beam weights, some structures in the fingers of a hand may irregularly reflect energy back to the antenna panels 430, and the UE 115 may perform additional processing to account for the reflections (e.g., with appropriate phase shifter and amplitude control adaptations). Because predictions of how a hand may affect (e.g., skew) the signal may be dynamic, such additional processing (e.g., phase changes) may be performed in a mission mode of operation, during which aperiodic or periodic CSI-RS symbols are signaled. Thus, adaptive or dynamic beam weight methods may be challenging to implement at the UE 115 (e.g., in mission-mode with more antenna elements 432, based on power constraints, thermal constraints, maximum power extrapolation (MPE) constraints, and other factors) and may increase processing complexity at the UE 115.

In accordance with various techniques described herein, the network entity 105 (e.g., using an AI/ML model 440) may assist the UE 115 with mitigation of blockage(s) 425 at the one or more antenna panels 430. In some examples, the UE 115 may be configured (e.g., as part of one or more industry standard protocols) to feedback various information (e.g., a channel quality index (CQI), a precoding matrix indicator (PMI), a rank indicator (RI)) via one or more reports (e.g., as part of a CSI report configuration, or transmission configuration indicator (TCI) state or reference signal received power (RSRP) feedback as a part of a synchronization signal block (SSB) report configuration). In some examples, the UE 115 may (e.g., in addition to the feedback information) determine whether one or more antenna panels 430 (e.g., an antenna panel 430 used at its end) are impacted by a blockage 425 or are not impacted by a blockage 425. The UE 115 may include a result of the determination in a set of blockage characteristics 415 and may transmit first information 405 that is indicative of the blockage characteristics 415 (e.g., may feedback the information to a gNB).

In some examples, the blockage characteristics 415 (e.g., or other feedback information) may include one or more binary indications (e.g., a 1-bit indication, an indication of whether an antenna panel 430 is impacted by blockage or not). Additionally, or alternatively, the blockage characteristics 415 may include or more detailed information associated with the nature of a blockage 425 (e.g., using one or more bits, or some other indication mechanism). In some examples, a binary feedback of an antenna panel 430 impacted by a blockage 425 may include a bit that indicates the data is for AI/ML training (e.g., a labeling of data for AI/ML training). In some examples, the blockage characteristics 415 may include a strength of a hand grip (e.g., as measured by one or more sensors), a quantity of fingers that block the antenna panel(s) 430, one or more properties of the blockage 425 (e.g., properties of the hand, such as skin properties, whether the skin is reflective or absorbent), or any combination thereof.

In some examples, the blockage characteristics 415 may additionally, or alternatively, include an indication of one or more sets of beam weights associated with blockage mitigation. That is, the UE 115 may also feedback a quantized version of one or more adaptive or dynamic beam weights that may mitigate blockage(s) 425. Such feedback may be provided based on a configuration (e.g., a reporting configuration) received from the network entity 105 (e.g., which may be associated with low feedback overhead). For example, the network entity 105 may configure a set of reporting occasions (e.g., in accordance with a given periodicity and/or frequency resources) during which the UE 115 may report the first information 405. Thus, in some examples, the UE 115 may report the blockage characteristics 415 based on the configuration from the network entity 105.

The UE 115 may detect the blockage characteristics 415 using various methods. For example, the UE 115 may include one or more sensors 450 (e.g., proximity sensor, grip sensor, and other sensors) that may be used to detect a presence of a blockage 425 (e.g., a hand, fingers) near antenna elements 432 in an antenna panel 430. In some examples, an impinging wave at a given frequency (e.g., infra-red (IR)) may be used to detect a blockage 425 based on a change in an electromagnetic characteristic of the impinging wave. In particular, IR proximity sensors may be used for head detection, which may be used to perform a power backoff (e.g., for regulatory compliance). In some examples, an impedance tuner system and a feedback receiver (FBRx) may detect a hand loading of an antenna panel 430 (e.g., FR1/FR2 antennas). A finger presence may be detected with transmit/receive radar antennas (e.g., integrated at 24 GHz industrial, scientific, and medical (ISM) band or at 60 GHz). Such radar antenna may use frequency modulated continuous wave (FMCW) transmissions to detect reflections off the hand and detect finger presence based on the reflections.

In some examples, each sensor 450 (e.g., each proximity sensor) may be associated with a specific antenna panel 430 (e.g., a first sensor 450 may be associated with the antenna panel 430-a, a second sensor 450 may be associated with the antenna panel 430-b, and so on). That is, the UE 115 may use multiple sensors 450 when the UE 115 includes multiple antenna panels 430. Further, because a location of an antenna panel 430 may be known a priori, the position of a blockage 425 (e.g., the fingers) may be inferred based on the location of the associated sensor 450 (e.g., along with the sensor data).

In some examples, the network entity 105 may use the blockage characteristics 415 from the UE 115 (e.g., and from one or more other UEs 115 (not shown)) for training an AI/ML model 440. In some examples, training the AI/ML model 440 may occur at an AI/ML server implemented by the network entity 105, or by a separate entity in the network (e.g., a different network entity 105 (not shown)). In some examples, the AI/ML server may train the AI/ML model 440 (e.g., a hand blockage module) using feedback information (e.g., the blockage characteristics 415) from multiple users (e.g., multiple UEs 115).

In some examples, the UE 115 may transmit different sets of blockage characteristics 415 at multiple instances or using multiple messages. For example, the UE 115 may transmit third information 435 that includes a first set of blockage characteristics 415 that is associated with training of the AI/ML model 440 (e.g., training data). At another time, the UE 115 may transmit the first information 405, which may include another set of blockage characteristics 415 that is to be used as input to the AI/ML model 440 (e.g., input data).

In some examples, when a UE transmits the blockage characteristics 415 (e.g., reports a hand blockage mode again, including a measure of strength of hand grip) to the network entity 105, the network entity 105 may transmit the blockage characteristics 415 to the AI/ML server (e.g., which may be included in the network entity 105). The AI/ML server may then transmit (e.g., feed forward, convey, indicate, output) one or more sets of beam weights to be used by the UE 115 to the network entity 105 based on the AI/ML model (e.g., the learned AI/ML model). In some examples, the AI/ML server may also transmit a seed value, which may ease an adaptive beam weight search at the UE 115. A “seed value” may refer to a set of relevant beam weights from a quantized dictionary of beam weights. For example, if w₁, . . . , w_{K} form a set of quantized dictionary of beam weights (e.g., agreed by both AI/ML server and UEs 115), the AI/ML server (e.g., the network entity 105) may output one or more indices 455 i₁, . . . , i_{L} (e.g., respectively corresponding to the sets, w₁, . . . , w_{K}). In some examples, the UE 115 may receive one or more indices 455 (e.g., i₁ and i₂) from a full set of indices (e.g., i₁, . . . , i_{L}) associated with the dictionary of beam weights. In some examples, “L” may refer to a quantity of sets of beam weights indicated by AI/ML server and may be configured or recommended by the UE 115 or the network entity 105. In response to obtaining the output from the AI/ML model 440, the network entity 105 may transmit second information 410 (e.g., assistance information) to the UE 115. The second information may include one or more first sets of beam weights 420 (e.g., which may have been output by the AI/ML model 440) or one or more seed values associated with the beam weights 420.

In some examples, the UE 115 may use the second information 410 (e.g., the seed values fed forward by the AI/ML server) to perform a local beam weight search (e.g., for adaptive beam weight determination) to mitigate the blockage(s) 425. That is, the UE 115 may determine (e.g., calculate, obtain, select) one or more second sets of beam weights 445 based on the one or more first sets of beam weights 420 and may communicate with the network entity 105 in accordance with the second sets of beam weights 445. Alternatively, the UE 115 may perform its own search to determine the one or more second sets of beam weights 445 (e.g., the UE 115 may disregard the one or more first sets of beam weights 420). In some examples, the seed values output by the AI/ML server may be used for reduced-complexity phase adaptation. For example, the UE 115 may be enabled to search a configured (e.g., finite) quantity (e.g., a subset) of beam weight sets around the seed value(s) (e.g., as opposed to searching all possible sets of beam weights), or to search over a finite parameter set that is based on the seed value(s).

In some examples, the UE 115 may determine the one or more second sets of beam weights 445 in accordance with a quantization of the one or more first sets of beam weights 420 that satisfies one or more communication thresholds (e.g., phase shifter and amplitude control constraints). For example, if the AI/ML model 440 output the sets of beam weights, wᵢ_{₁}, . . . , wᵢ_{_{L}}, the UE 115 may calculate adaptive beam weights using Equation 1.

$$E [ h \vert {w}_{{i}_{1}} , … , {w}_{{i}_{L}} ] = Q ( {u}_{1} ( {w}_{{i}_{1}} {w}_{{i}_{1}}^{H} + … + {w}_{{i}_{L}} {w}_{{i}_{L}}^{H} ) ) \qquad ( 1 )$$

In the example of Equation 1, the term, E[h|wᵢ_{₁}, . . . , wᵢ_{_{L}}], may refer to a conditional expectation of the channel impulse response (CIR) based on the one or more first sets of beam weights 420 (e.g., the AI/ML feedback of seed). Additionally, the term,

$${u}_{1} ( {w}_{{i}_{1}} {w}_{{i}_{1}}^{H} + … + {w}_{{i}_{L}} {w}_{{i}_{L}}^{H} ) ,$$

may refer to an eigenvector (e.g., the dominant eigenvector) of the underlying matrix associated with the beam weights, and the term,

$$Q ( {u}_{1} ( {w}_{{i}_{1}} {w}_{{i}_{1}}^{H} + … + {w}_{{i}_{L}} {w}_{{i}_{L}}^{H} ) ) ,$$

may refer to the quantization of the eigenvector that satisfies one or more phase shifter and amplitude control constraints.

Thus, by applying one or more techniques described herein, the wireless communications system 400 may be associated with improved communication reliability and improved data rates. For example, by providing the first information 405 to the network entity 105, the UE 115 may more efficiently and effectively determine beam weights that mitigate blockages 425 of antenna panels 430, thus increasing system performance. Additionally, by training the AI/ML model 440 using the blockage characteristics 415 from one or more UEs 115, the network entity may quickly provide beam weight suggestions to each UE 115, which may reduce overall power consumption and increase communication reliability between devices. As such, the UE 115 may be enabled with robust blockage mitigation, which may improve overall user experience in the wireless communications system 400.

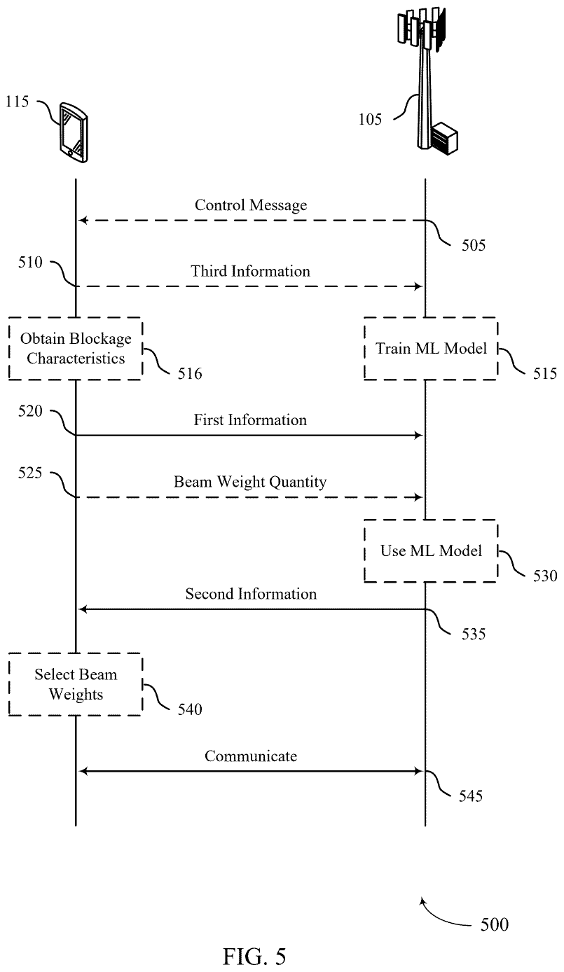

FIG. 5 shows an example of a process flow 500 that supports machine learning blockage mitigation in accordance with one or more aspects of the present disclosure. In some examples, the process flow 500 may implement aspects of the wireless communications system 100, the network architecture 200, the ANN 300, and the wireless communications system 400. The UE 115 and the network entity 105 of the process flow 500 may be examples of corresponding devices herein, including with reference to FIGS. 1 through 4. In the following description of the process flow 500, the operations between the UE 115 and the network entity 105 may be performed in a different order than the order shown, or other operations may be added or removed from the process flow 500. For example, some operations may also be left out of the process flow 500, or may be performed in different orders or at different times. Further, although some operations or signaling may be shown to occur at different times for discussion purposes, these operations may actually occur at the same time. Although the UE 115 and the network entity 105 are shown performing the operations of the process flow 500, some aspects of some operations may also be performed by one or more other wireless or network devices.

At 505, in some examples, the UE 115 may receive (e.g., obtain, acquire) a control message including configuration information associated with one or more reporting occasions, which may be output (e.g., transmitted, conveyed) by the network entity 105. In some examples, transmission of first information (e.g., including training data or input data to an AI/ML model) may occur within the one or more reporting occasions based on the configuration information. That is, the network entity 105 may output a reporting configuration for hand blockage information, which the UE 115 may use to report one or more characteristics associated with a blockage of one or more antenna panels.

At 510, in some examples, the UE 115 may transmit (e.g., prior to transmission of the first information) third information (e.g., third information 435), which may be obtained (e.g., received, acquired) by the network entity 105. The third information may include data associated with training an ML model (e.g., an AI/ML model 440) at a network entity 105. In some examples, the third information may be indicative of a set of characteristics (e.g., blockage characteristics 415) associated with a blockage (e.g., blockage 425) of one or more antenna panels (e.g., antenna panels 430). In some examples, a reception of second information (e.g., at 535) may be based on reception of an output of the ML model. In some examples, the third information may include sensor-based feedback (e.g., characterizing a nature of a hand blockage), adaptive beam weights that may mitigate a blockage, other information associated with the blockage, or any combination thereof. At 516, in some examples, the network entity 105 may train the ML model based on the third information.

At 515, in some examples, the UE 115 may obtain a set of characteristics (e.g., blockage characteristics 415) from one or more sensors associated with detection of the blockage (e.g., blockage 425) at the one or more antenna panels (e.g., antenna panels 430). In some examples, the set of characteristics may be indicated via the first information based on data obtained from the one or more sensors (e.g., based on obtaining the sensor data).

At 520, the UE 115 may the transmit first information, which may be obtained by the network entity 105. The first information may be indicative of the set of characteristics associated with the blockage of the one or more antenna panels of the UE 115. In some examples, the blockage may be associated with a hand blockage or a body blockage, and the set of characteristics may include a grip strength of the hand blockage, a quantity of fingers that block the one or more antenna panels, a skin property of the hand blockage, a body tissue characteristic associated with the body blockage, or any combination thereof. In some examples, the first information may include an indication of one or more third sets of beam weights associated with mitigation of the blockage (e.g., beam weights that the UE 115 may have selected without assistance from the network entity 105, beam weights available from blockage mitigation). In some examples, the first information may be associated with input data for an ML model at the network entity 105 (e.g., associated with reporting of a nature of the blockage in current operating conditions). In some examples, the network entity 105 may use the first information to update (e.g., further train) the ML model.

At 525, in some examples, the UE 115 may transmit, prior to reception of second information, an indication of a requested quantity of beam weights, which may be obtained by the network entity 105. In some examples, a quantity of beam weights of one or more first sets of beam weights (e.g., included in second information) received from the network entity 105 may be based on the requested quantity.

At 530, in some examples, the network entity 105 may use an ML model (e.g., the AI/ML model 440, an ANN 300 trained for blockage mitigation) to obtain second information based on the first information. In some examples, the second information may be indicative of one or more first sets of beam weights (e.g., one or more first sets of beam weights 420) to be used at the one or more antenna panels of the UE 115.

At 535, the UE 115 may receive second information associated with mitigation of the blockage based on transmission of the first information, which may be output by the network entity 105. In some examples, the second information may be associated with an output of the ML model that is based on the input data (e.g., the first information). In some examples, the second information may include seed information associated with reducing processing time (e.g., adaptive beam weight search time) at the UE 115. In some examples, receiving the second information may include receiving a first index (e.g., i₁) associated with a first set of beam weights (e.g., w₁) of the one or more first sets of beam weights (e.g., w₁, . . . , w_{K}). In such examples, the first index may be one of multiple indices that are each associated with a respective set of beam weights of the one or more first sets of beam weights.

At 540, in some examples, the UE 115 may select the one or more second sets of beam weights (e.g., one or more second sets of beam weights 445) from multiple available sets of beam weights. The multiple sets of available beam weights may be defined based on the one or more first sets of beam weights (e.g., may be a subset of beam weights of a quantized dictionary of beam weight sets, which may reduce a search space for the UE 115). Accordingly, the UE 115 may, for example, use the one or more second sets of beam weights to speed up an adaptive beam weight determination.

At 545, the UE 115 and the network entity 105 may communicate in accordance with one or more second sets of beam weights derived from the one or more first sets of beam weights (e.g., with the determined adaptive beam weights). That is, the UE 115 may improve its blockage mitigation techniques based on the assistance from the network entity 105. Thus, by utilizing the techniques herein, the UE 115 and the ne5 may support increased communication reliability and other performance enhancements for a wireless communications system.

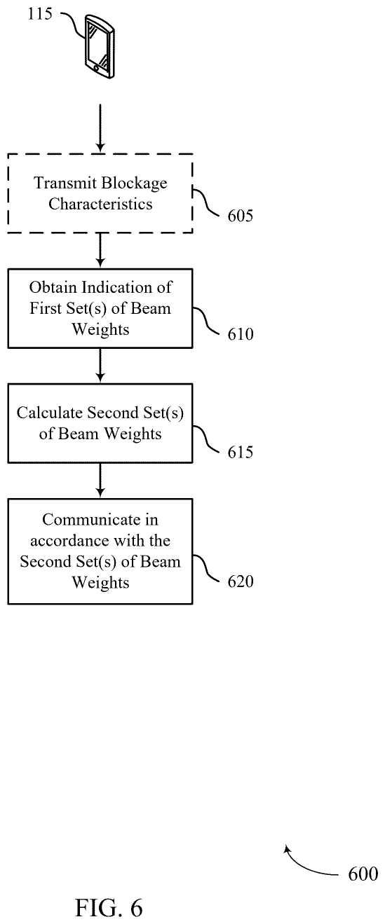

FIG. 6 shows an example of a process flow 600 that supports ML blockage mitigation in accordance with one or more aspects of the present disclosure. In some examples, the process flow 600 may implement aspects of the wireless communications system 100, the network architecture 200, the ANN 300, the wireless communications system 400, and the process flow 500. The UE 115 of the process flow 600 may be an example of corresponding devices herein, including with reference to FIGS. 1 through 5. In the following description of the process flow 600, the operations of the UE 115 may be performed in a different order than the order shown, or other operations may be added or removed from the process flow 600. For example, some operations may also be left out of the process flow 600, or may be performed in different orders or at different times. Although the UE 115 is shown performing the operations of the process flow 600, some aspects of some operations may also be performed by one or more other wireless or network devices (e.g., a network entity 105).

At 605, in some examples, the UE 115 may transmit first information (e.g., first information 405) that is indicative of a set of characteristics associated with the blockage (e.g., blockage characteristics 415). The first information may be associated with input data for an ML model at a network entity 105. In some examples, one or more first sets of beam weights may be obtained based on second information received from an output of the ML model that is based on the input data.

At 610, the UE 115 may obtain an indication of one or more first sets of beam weights (e.g., one or more first sets of beam weights 420, or obtained from information stored at the UE 115) associated with mitigation of a blockage of one or more antenna panels of the UE 115. In some examples, obtaining the indication may include obtaining one or more third sets of beam weights that are inferred based on an ML model (e.g., deployed at a network entity 105 or at the UE 115). Additionally, or alternatively, the UE 115 may select the one or more first sets of beam weights from a set of multiple available beam weights. In such examples, the set of multiple available beam weights may be defined based on the one or more third sets of beam weights.

At 615, the UE 115 may calculate one or more second sets of beam weights to use for communications. The one or more second sets of beam weights may be based on a quantization of the one or more first sets of beam weights (e.g., in accordance with Equation 1 as described with reference to FIG. 4). In some examples, the quantization may satisfy one or more communication thresholds. For example, the one or more communication thresholds may include one or more phase shift thresholds, one or more amplitude thresholds, other thresholds, or any combination thereof. In some examples, calculating the second sets of beam weights may include determining a linear combination of the one or more first sets of beam weights (e.g., a dominant eigenvector), and the quantization of the one or more first sets of beam weights may be based on the linear combination.

At 620, communicate in accordance with the one or more second sets of beam weights derived from the one or more first sets of beam weights. In some examples, the one or more second sets of beam weights may be different than the one or more first sets of beam weights or may be the same as the one or more first sets of beam weights. Thus, by determining the one or more second sets of beam weights based on the first set(s), the UE 115 may support flexible techniques for blockage mitigation. Such implementations may increase communication reliability, increase data rates, and improve overall user experience associated with the UE 115 and other aspects of the wireless communications system.

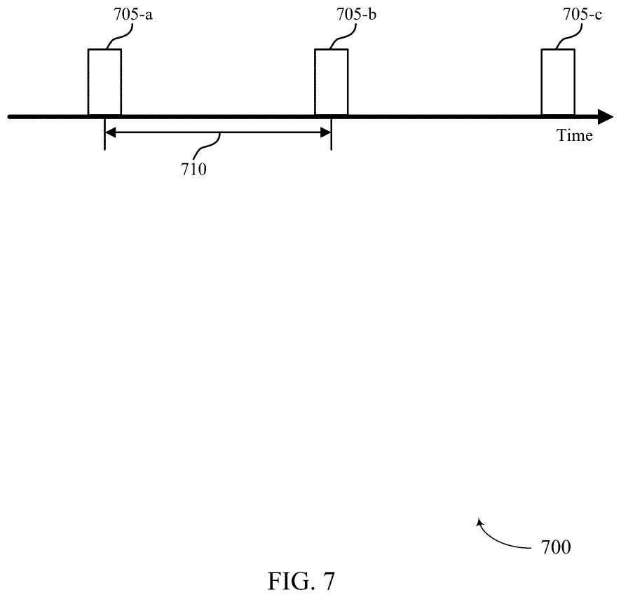

FIG. 7 shows an example of a timing diagram 700 that supports machine learning blockage mitigation in accordance with one or more aspects of the present disclosure. In some examples, the timing diagram 700 may be implemented by aspects of the wireless communications system 100, the network architecture 200, the ANN 300, and the wireless communications system 400. For example, a UE 115 and a network entity 105 may communicate in accordance with one aspects of the timing diagram 700.

In some examples, the UE 115 may transmit blockage feedback information and other information may be provided based on a reporting configuration received from the network entity 105. For example, the network entity 105 and/or an AI-ML server may configure a set of UE reporting occasions 705, a period 710, or other resources (e.g., frequency resources) for the UE reporting occasions 705. The UE reporting occasions 705 may be resources during which the UE 115 may report the first information 405. Thus, in some examples, the UE 115 may report the blockage characteristics 415 based on the configuration from the network entity 105. The UE 115 may be configured to report blockage feedback (e.g., proximity sensor-based feedback) in one or more of the UE reporting occasions 705. For example, the UE 115 may be configured to report the first information in a UE reporting occasion 705-a (e.g., a first occasion) and not in the UE reporting occasion 705-b or the UE reporting occasions 705-c.

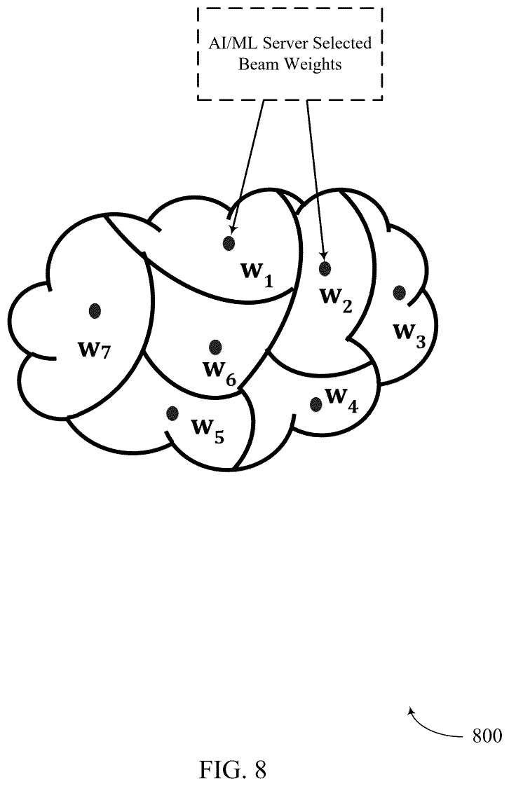

FIG. 8 shows an example of a beam weight dictionary 800 that supports machine learning blockage mitigation in accordance with one or more aspects of the present disclosure. In some examples, the beam weight dictionary 800 may be implemented by aspects of the wireless communications system 100, the network architecture 200, the ANN 300, and the wireless communications system 400. For example, a UE 115, a network entity 105, or both may utilize aspects of the beam weight dictionary 800. For example, the beam weight dictionary 800 may represent a pictorial illustration of a UE 115 determination of adaptive beam weights for use based on AI/ML feedback.

In some examples, the beam weight dictionary 800 may include a quantized dictionary of beam weight sets (e.g., w₁, w₂, w₃, w₄, w₅, w₆, w₇). Although the non-limiting example of FIG. 8 shows seven beam weight sets, any quantity of beam weight sets w_{K} may be configured (e.g., “K” may be any integer value). As described herein, an AI/ML server may feedback one or more likely adaptive beam weight sets (e.g., w₁ and w₂, via the first sets of beam weights 420) that the UE 115 may use for blockage mitigation. Thus, by receiving the beam weight sets output by the AI/ML server, the UE 115 may be provided with predicted beam weight sets that may allow the UE to more effectively (e.g., with reduced processing, or with increased accuracy) reduce the adverse effects of antenna panel blockages.

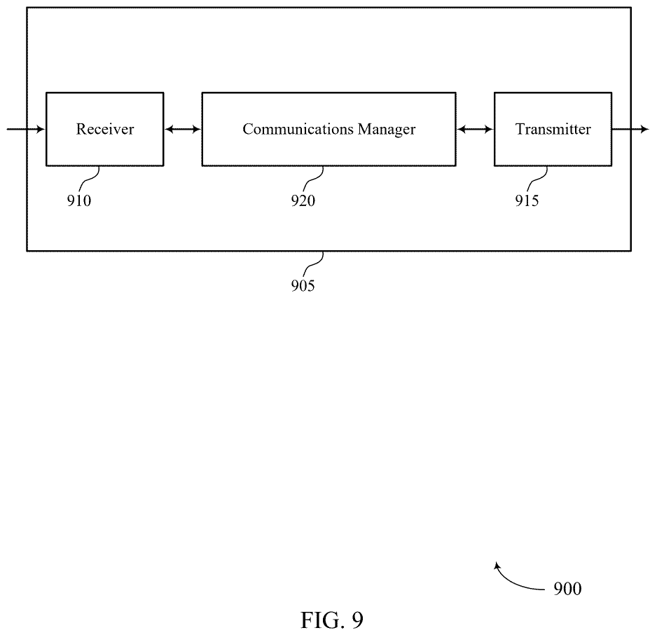

FIG. 9 shows a block diagram 900 of a device 905 that supports machine learning blockage mitigation in accordance with one or more aspects of the present disclosure. The device 905 may be an example of aspects of a UE 115 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques. Each of these components may be in communication with one another (e.g., via one or more buses).

The receiver 910 may provide a means for receiving information such as packets, user data, control information, or any combination thereof associated with various information channels (e.g., control channels, data channels, information channels related to machine learning blockage mitigation). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to machine learning blockage mitigation). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations or components thereof may be examples of means for performing various aspects of machine learning blockage mitigation as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a digital signal processor (DSP), a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for transmitting first information that is indicative of a set of characteristics associated with a blockage of one or more antenna panels of the UE. The communications manager 920 is capable of, configured to, or operable to support a means for receiving second information associated with mitigation of the blockage based on transmission of the first information, the second information indicative of one or more first sets of beam weights to be used at the one or more antenna panels of the UE. The communications manager 920 is capable of, configured to, or operable to support a means for communicating in accordance with one or more second sets of beam weights derived from the one or more first sets of beam weights.

Additionally, or alternatively, the communications manager 920 may support wireless communications in accordance with examples as disclosed herein. For example, the communications manager 920 is capable of, configured to, or operable to support a means for obtaining an indication of one or more first sets of beam weights associated with mitigation of a blockage of one or more antenna panels of the UE. The communications manager 920 is capable of, configured to, or operable to support a means for calculating one or more second sets of beam weights to use for communications by the UE, the one or more second sets of beam weights based on a quantization of the one or more first sets of beam weights that satisfies one or more communication thresholds. The communications manager 920 is capable of, configured to, or operable to support a means for communicating in accordance with the one or more second sets of beam weights derived from the one or more first sets of beam weights.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for more efficient utilization of communication resources and other benefits.

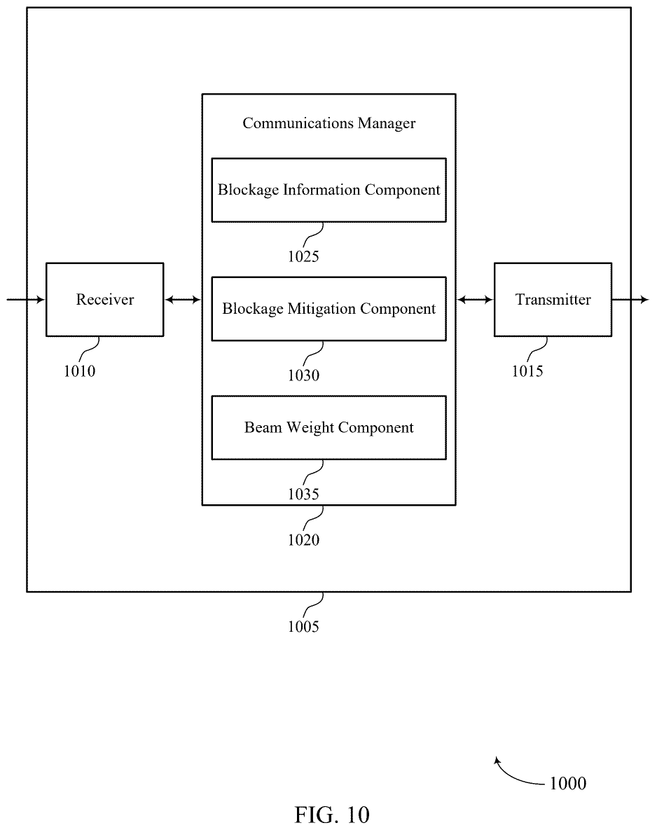

FIG. 10 shows a block diagram 1000 of a device 1005 that supports machine learning blockage mitigation in accordance with one or more aspects of the present disclosure. The device 1005 may be an example of aspects of a device 905 or a UE 115 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for receiving information such as packets, user data, control information, or any combination thereof associated with various information channels (e.g., control channels, data channels, information channels related to machine learning blockage mitigation). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to machine learning blockage mitigation). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of machine learning blockage mitigation as described herein. For example, the communications manager 1020 may include a blockage information component 1025, a blockage mitigation component 1030, a beam weight component 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The blockage information component 1025 is capable of, configured to, or operable to support a means for transmitting first information that is indicative of a set of characteristics associated with a blockage of one or more antenna panels of the UE. The blockage mitigation component 1030 is capable of, configured to, or operable to support a means for receiving second information associated with mitigation of the blockage based on transmission of the first information, the second information indicative of one or more first sets of beam weights to be used at the one or more antenna panels of the UE. The beam weight component 1035 is capable of, configured to, or operable to support a means for communicating in accordance with one or more second sets of beam weights derived from the one or more first sets of beam weights.

Additionally, or alternatively, the communications manager 1020 may support wireless communications in accordance with examples as disclosed herein. The blockage mitigation component 1030 is capable of, configured to, or operable to support a means for obtaining an indication of one or more first sets of beam weights associated with mitigation of a blockage of one or more antenna panels of the UE. The beam weight component 1035 is capable of, configured to, or operable to support a means for calculating one or more second sets of beam weights to use for communications by the UE, the one or more second sets of beam weights based on a quantization of the one or more first sets of beam weights that satisfies one or more communication thresholds. The beam weight component 1035 is capable of, configured to, or operable to support a means for communicating in accordance with the one or more second sets of beam weights derived from the one or more first sets of beam weights.

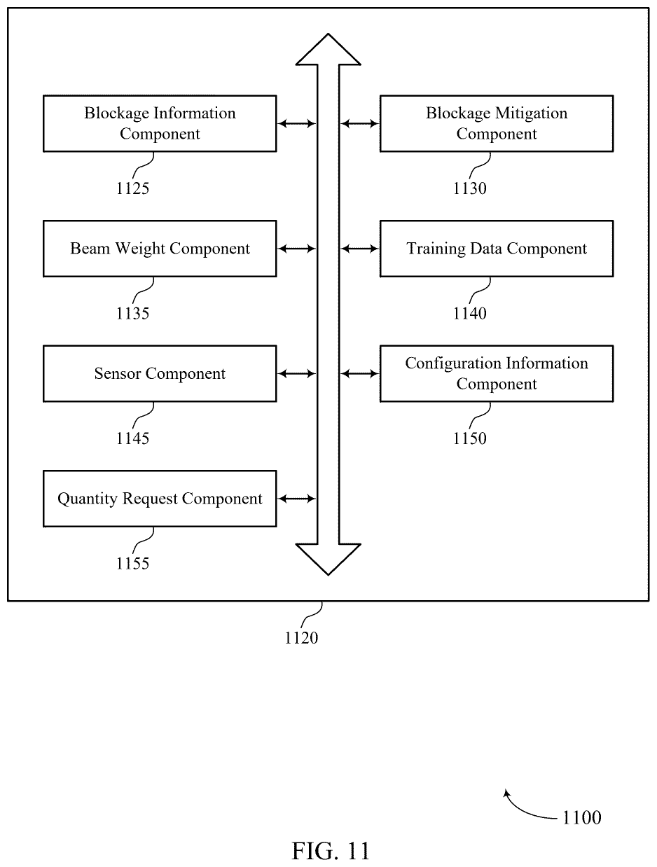

FIG. 11 shows a block diagram 1100 of a communications manager 1120 that supports machine learning blockage mitigation in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of machine learning blockage mitigation as described herein. For example, the communications manager 1120 may include a blockage information component 1125, a blockage mitigation component 1130, a beam weight component 1135, a training data component 1140, a sensor component 1145, a configuration information component 1150, a quantity request component 1155, or any combination thereof. Each of these components, or components or subcomponents thereof (e.g., one or more processors, one or more memories), may communicate, directly or indirectly, with one another (e.g., via one or more buses).

The communications manager 1120 may support wireless communications in accordance with examples as disclosed herein. The blockage information component 1125 is capable of, configured to, or operable to support a means for transmitting first information that is indicative of a set of characteristics associated with a blockage of one or more antenna panels of the UE. The blockage mitigation component 1130 is capable of, configured to, or operable to support a means for receiving second information associated with mitigation of the blockage based on transmission of the first information, the second information indicative of one or more first sets of beam weights to be used at the one or more antenna panels of the UE. The beam weight component 1135 is capable of, configured to, or operable to support a means for communicating in accordance with one or more second sets of beam weights derived from the one or more first sets of beam weights.

In some examples, the training data component 1140 is capable of, configured to, or operable to support a means for transmitting, prior to transmission of the first information, third information for training a machine learning model at a network entity, the third information indicative of a second set of characteristics associated with a second blockage of the one or more antenna panels, where reception of the second information is based on reception of an output of the machine learning model.

In some examples, the blockage is associated with a hand blockage or a body blockage. In some examples, the set of characteristics includes a grip strength of the hand blockage, a quantity of fingers that block the one or more antenna panels, a skin property of the hand blockage, a body tissue characteristic associated with the body blockage, or any combination thereof.

In some examples, the sensor component 1145 is capable of, configured to, or operable to support a means for obtaining the set of characteristics from one or more sensors associated with detection of the blockage at the one or more antenna panels, where the set of characteristics indicated via the first information is based on data obtained from the one or more sensors.

In some examples, the first information includes an indication of one or more third sets of beam weights associated with mitigation of the blockage.

In some examples, the configuration information component 1150 is capable of, configured to, or operable to support a means for receiving a control message including configuration information associated with one or more reporting occasions, where transmission of the first information occurs within the one or more reporting occasions based on the configuration information.

In some examples, the first information is associated with input data for a machine learning model at a network entity. In some examples, the second information is associated with an output of the machine learning model that is based on the input data.

In some examples, to support receiving the second information, the blockage mitigation component 1130 is capable of, configured to, or operable to support a means for receiving a first index associated with a first set of beam weights of the one or more first sets of beam weights, where the first index is one of a set of multiple indices that are each associated with a respective set of beam weights of the one or more first sets of beam weights.

In some examples, the quantity request component 1155 is capable of, configured to, or operable to support a means for transmitting, prior to reception of the second information, an indication of a requested quantity of beam weights, where a quantity of beam weights of the one or more first sets of beam weights is based on the requested quantity.

In some examples, the beam weight component 1135 is capable of, configured to, or operable to support a means for selecting the one or more second sets of beam weights from a set of multiple available beam weights, where the set of multiple available beam weights is defined based on the one or more first sets of beam weights.

Additionally, or alternatively, the communications manager 1120 may support wireless communications in accordance with examples as disclosed herein. In some examples, the blockage mitigation component 1130 is capable of, configured to, or operable to support a means for obtaining an indication of one or more first sets of beam weights associated with mitigation of a blockage of one or more antenna panels of the UE. In some examples, the beam weight component 1135 is capable of, configured to, or operable to support a means for calculating one or more second sets of beam weights to use for communications by the UE, the one or more second sets of beam weights based on a quantization of the one or more first sets of beam weights that satisfies one or more communication thresholds. In some examples, the beam weight component 1135 is capable of, configured to, or operable to support a means for communicating in accordance with the one or more second sets of beam weights derived from the one or more first sets of beam weights.

In some examples, to support calculating the one or more second sets of beam weights, the beam weight component 1135 is capable of, configured to, or operable to support a means for determining a linear combination of the one or more first sets of beam weights, the quantization of the one or more first sets of beam weights based on the linear combination.

In some examples, to support obtaining the one or more first sets of beam weights, the blockage mitigation component 1130 is capable of, configured to, or operable to support a means for obtaining one or more third sets of beam weights that are inferred based on a machine learning model. In some examples, to support obtaining the one or more first sets of beam weights, the beam weight component 1135 is capable of, configured to, or operable to support a means for selecting the one or more first sets of beam weights from a set of multiple available beam weights, where the set of multiple available beam weights is defined based on the one or more third sets of beam weights.

In some examples, the training data component 1140 is capable of, configured to, or operable to support a means for transmitting first information that is indicative of a set of characteristics associated with the blockage, the first information associated with input data for a machine learning model at a network entity, where the one or more first sets of beam weights are obtained based on second information received from an output of the machine learning model that is based on the input data.

In some examples, the one or more communication thresholds include one or more phase shift thresholds, one or more amplitude thresholds, or both.

In some examples, the one or more second sets of beam weights are different than the one or more first sets of beam weights.

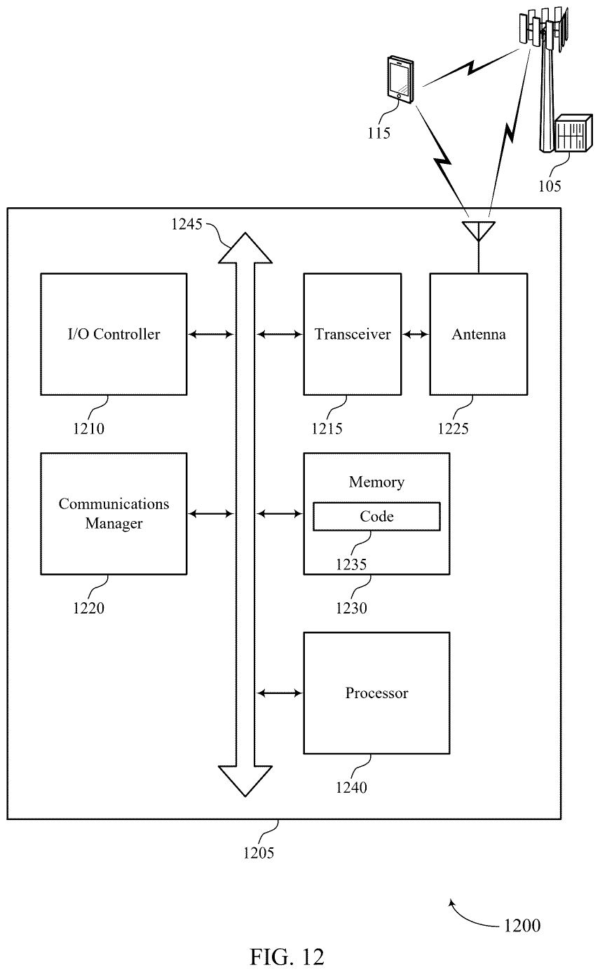

FIG. 12 shows a diagram of a system 1200 including a device 1205 that supports machine learning blockage mitigation in accordance with one or more aspects of the present disclosure. The device 1205 may be an example of or include components of a device 905, a device 1005, or a UE 115 as described herein. The device 1205 may communicate (e.g., wirelessly) with one or more other devices (e.g., network entities 105, UEs 115, or a combination thereof). The device 1205 may include components for bi-directional voice and data communications including components for transmitting and receiving communications, such as a communications manager 1220, an input/output (I/O) controller, such as an I/O controller 1210, a transceiver 1215, one or more antennas 1225, at least one memory 1230, code 1235, and at least one processor 1240. These components may be in electronic communication or otherwise coupled (e.g., operatively, communicatively, functionally, electronically, electrically) via one or more buses (e.g., a bus 1245).

The I/O controller 1210 may manage input and output signals for the device 1205. The I/O controller 1210 may also manage peripherals not integrated into the device 1205. In some cases, the I/O controller 1210 may represent a physical connection or port to an external peripheral. In some cases, the I/O controller 1210 may utilize an operating system such as iOS®, ANDROID®, MS-DOS®, MS-WINDOWS®, OS/2®, UNIX®, LINUX®, or another known operating system. Additionally, or alternatively, the I/O controller 1210 may represent or interact with a modem, a keyboard, a mouse, a touchscreen, or a similar device. In some cases, the I/O controller 1210 may be implemented as part of one or more processors, such as the at least one processor 1240. In some cases, a user may interact with the device 1205 via the I/O controller 1210 or via hardware components controlled by the I/O controller 1210.

In some cases, the device 1205 may include a single antenna. However, in some other cases, the device 1205 may have more than one antenna, which may be capable of concurrently transmitting or receiving multiple wireless transmissions. The transceiver 1215 may communicate bi-directionally via the one or more antennas 1225 using wired or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The at least one memory 1230 may include random access memory (RAM) and read-only memory (ROM). The at least one memory 1230 may store computer-readable, computer-executable, or processor-executable code, such as the code 1235. The code 1235 may include instructions that, when executed by the at least one processor 1240, cause the device 1205 to perform various functions described herein. The code 1235 may be stored in a non-transitory computer-readable medium such as system memory or another type of memory. In some cases, the code 1235 may not be directly executable by the at least one processor 1240 but may cause a computer (e.g., when compiled and executed) to perform functions described herein. In some cases, the at least one memory 1230 may include, among other things, a basic I/O system (BIOS) which may control basic hardware or software operation such as the interaction with peripheral components or devices.

The at least one processor 1240 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1240 may be configured to operate a memory array using a memory controller. In some other cases, a memory controller may be integrated into the at least one processor 1240. The at least one processor 1240 may be configured to execute computer-readable instructions stored in a memory (e.g., the at least one memory 1230) to cause the device 1205 to perform various functions (e.g., functions or tasks supporting machine learning blockage mitigation). For example, the device 1205 or a component of the device 1205 may include at least one processor 1240 and at least one memory 1230 coupled with or to the at least one processor 1240, the at least one processor 1240 and the at least one memory 1230 configured to perform various functions described herein.

In some examples, the at least one processor 1240 may include multiple processors and the at least one memory 1230 may include multiple memories. One or more of the multiple processors may be coupled with one or more of the multiple memories, which may, individually or collectively, be configured to perform various functions described herein. In some examples, the at least one processor 1240 may be a component of a processing system, which may refer to a system (such as a series) of machines, circuitry (including, for example, one or both of processor circuitry (which may include the at least one processor 1240) and memory circuitry (which may include the at least one memory 1230)), or components, that receives or obtains inputs and processes the inputs to produce, generate, or obtain a set of outputs. The processing system may be configured to perform one or more of the functions described herein. For example, the at least one processor 1240 or a processing system including the at least one processor 1240 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code 1235 (e.g., processor-executable code) stored in the at least one memory 1230 or otherwise, to perform one or more of the functions described herein.

The communications manager 1220 may support wireless communications in accordance with examples as disclosed herein. For example, the communications manager 1220 is capable of, configured to, or operable to support a means for transmitting first information that is indicative of a set of characteristics associated with a blockage of one or more antenna panels of the UE. The communications manager 1220 is capable of, configured to, or operable to support a means for receiving second information associated with mitigation of the blockage based on transmission of the first information, the second information indicative of one or more first sets of beam weights to be used at the one or more antenna panels of the UE. The communications manager 1220 is capable of, configured to, or operable to support a means for communicating in accordance with one or more second sets of beam weights derived from the one or more first sets of beam weights.

Additionally, or alternatively, the communications manager 1220 may support wireless communications in accordance with examples as disclosed herein. For example, the communications manager 1220 is capable of, configured to, or operable to support a means for obtaining an indication of one or more first sets of beam weights associated with mitigation of a blockage of one or more antenna panels of the UE. The communications manager 1220 is capable of, configured to, or operable to support a means for calculating one or more second sets of beam weights to use for communications by the UE, the one or more second sets of beam weights based on a quantization of the one or more first sets of beam weights that satisfies one or more communication thresholds. The communications manager 1220 is capable of, configured to, or operable to support a means for communicating in accordance with the one or more second sets of beam weights derived from the one or more first sets of beam weights.

By including or configuring the communications manager 1220 in accordance with examples as described herein, the device 1205 may support techniques for improved communication reliability, reduced latency, more efficient utilization of communication resources, improved coordination between devices, and improved utilization of processing capability, among other benefits.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the at least one processor 1240, the at least one memory 1230, the code 1235, or any combination thereof. For example, the code 1235 may include instructions executable by the at least one processor 1240 to cause the device 1205 to perform various aspects of machine learning blockage mitigation as described herein, or the at least one processor 1240 and the at least one memory 1230 may be otherwise configured to, individually or collectively, perform or support such operations.

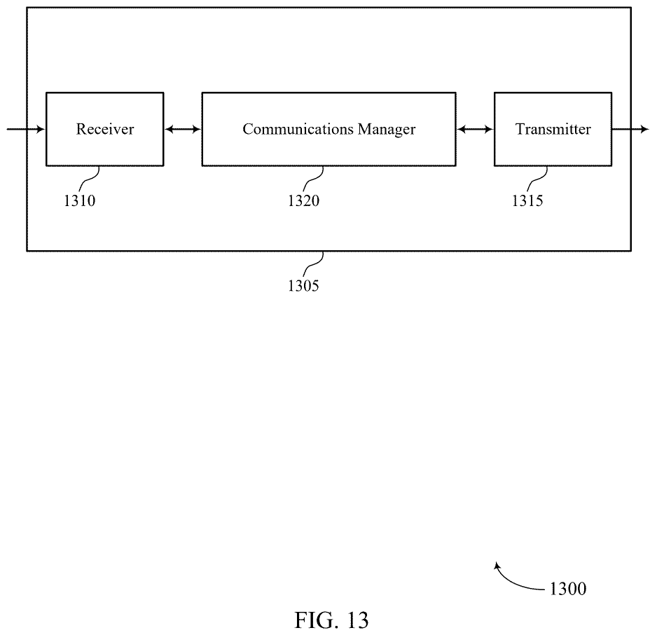

FIG. 13 shows a block diagram 1300 of a device 1305 that supports machine learning blockage mitigation in accordance with one or more aspects of the present disclosure. The device 1305 may be an example of aspects of a network entity 105 as described herein. The device 1305 may include a receiver 1310, a transmitter 1315, and a communications manager 1320. The device 1305, or one or more components of the device 1305 (e.g., the receiver 1310, the transmitter 1315, the communications manager 1320), may include at least one processor, which may be coupled with at least one memory, to, individually or collectively, support or enable the described techniques. Each of these components may be in communication with one another (e.g., via one or more buses).

The receiver 1310 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1305. In some examples, the receiver 1310 may support obtaining information by receiving signals via one or more antennas. Additionally, or alternatively, the receiver 1310 may support obtaining information by receiving signals via one or more wired (e.g., electrical, fiber optic) interfaces, wireless interfaces, or any combination thereof.

The transmitter 1315 may provide a means for outputting (e.g., transmitting, providing, conveying, sending) information generated by other components of the device 1305. For example, the transmitter 1315 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1315 may support outputting information by transmitting signals via one or more antennas. Additionally, or alternatively, the transmitter 1315 may support outputting information by transmitting signals via one or more wired (e.g., electrical, fiber optic) interfaces, wireless interfaces, or any combination thereof. In some examples, the transmitter 1315 and the receiver 1310 may be co-located in a transceiver, which may include or be coupled with a modem.

The communications manager 1320, the receiver 1310, the transmitter 1315, or various combinations or components thereof may be examples of means for performing various aspects of machine learning blockage mitigation as described herein. For example, the communications manager 1320, the receiver 1310, the transmitter 1315, or various combinations or components thereof may be capable of performing one or more of the functions described herein.

In some examples, the communications manager 1320, the receiver 1310, the transmitter 1315, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1320, the receiver 1310, the transmitter 1315, or various combinations or components thereof may be implemented in code (e.g., as communications management software or firmware) executed by at least one processor (e.g., referred to as a processor-executable code). If implemented in code executed by at least one processor, the functions of the communications manager 1320, the receiver 1310, the transmitter 1315, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1320 may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communications in accordance with examples as disclosed herein. For example, the communications manager 1320 is capable of, configured to, or operable to support a means for obtaining first information that is indicative of a set of characteristics associated with a blockage of one or more antenna panels of a UE. The communications manager 1320 is capable of, configured to, or operable to support a means for using a machine learning model to obtain second information based on the first information. The communications manager 1320 is capable of, configured to, or operable to support a means for outputting the second information based on usage of the machine learning model, the second information associated with mitigation of the blockage and indicative of one or more first sets of beam weights available to the UE. The communications manager 1320 is capable of, configured to, or operable to support a means for communicating in accordance with one or more second sets of beam weights derived from the one or more first sets of beam weights.

By including or configuring the communications manager 1320 in accordance with examples as described herein, the device 1305 (e.g., at least one processor controlling or otherwise coupled with the receiver 1310, the transmitter 1315, the communications manager 1320, or a combination thereof) may support techniques for more efficient utilization of communication resources, among other benefits.

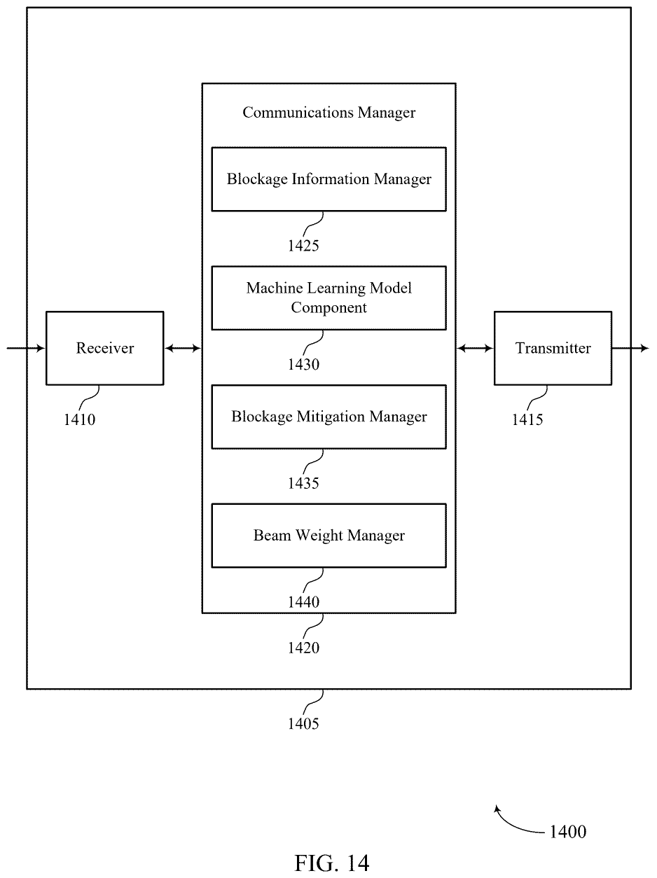

FIG. 14 shows a block diagram 1400 of a device 1405 that supports machine learning blockage mitigation in accordance with one or more aspects of the present disclosure. The device 1405 may be an example of aspects of a device 1305 or a network entity 105 as described herein. The device 1405 may include a receiver 1410, a transmitter 1415, and a communications manager 1420. The device 1405, or one or more components of the device 1405 (e.g., the receiver 1410, the transmitter 1415, the communications manager 1420), may include at least one processor, which may be coupled with at least one memory, to support the described techniques. Each of these components may be in communication with one another (e.g., via one or more buses).

The receiver 1410 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1405. In some examples, the receiver 1410 may support obtaining information by receiving signals via one or more antennas. Additionally, or alternatively, the receiver 1410 may support obtaining information by receiving signals via one or more wired (e.g., electrical, fiber optic) interfaces, wireless interfaces, or any combination thereof.

The transmitter 1415 may provide a means for outputting (e.g., transmitting, providing, conveying, sending) information generated by other components of the device 1405. For example, the transmitter 1415 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1415 may support outputting information by transmitting signals via one or more antennas. Additionally, or alternatively, the transmitter 1415 may support outputting information by transmitting signals via one or more wired (e.g., electrical, fiber optic) interfaces, wireless interfaces, or any combination thereof. In some examples, the transmitter 1415 and the receiver 1410 may be co-located in a transceiver, which may include or be coupled with a modem.

The device 1405, or various components thereof, may be an example of means for performing various aspects of machine learning blockage mitigation as described herein. For example, the communications manager 1420 may include a blockage information manager 1425, a machine learning model component 1430, a blockage mitigation manager 1435, a beam weight manager 1440, or any combination thereof. The communications manager 1420 may be an example of aspects of a communications manager 1320 as described herein. In some examples, the communications manager 1420, or various components thereof, may be configured to perform various operations (e.g., receiving, obtaining, monitoring, outputting, transmitting) using or otherwise in cooperation with the receiver 1410, the transmitter 1415, or both. For example, the communications manager 1420 may receive information from the receiver 1410, send information to the transmitter 1415, or be integrated in combination with the receiver 1410, the transmitter 1415, or both to obtain information, output information, or perform various other operations as described herein.

The communications manager 1420 may support wireless communications in accordance with examples as disclosed herein. The blockage information manager 1425 is capable of, configured to, or operable to support a means for obtaining first information that is indicative of a set of characteristics associated with a blockage of one or more antenna panels of a UE. The machine learning model component 1430 is capable of, configured to, or operable to support a means for using a machine learning model to obtain second information based on the first information. The blockage mitigation manager 1435 is capable of, configured to, or operable to support a means for outputting the second information based on usage of the machine learning model, the second information associated with mitigation of the blockage and indicative of one or more first sets of beam weights available to the UE. The beam weight manager 1440 is capable of, configured to, or operable to support a means for communicating in accordance with one or more second sets of beam weights derived from the one or more first sets of beam weights.

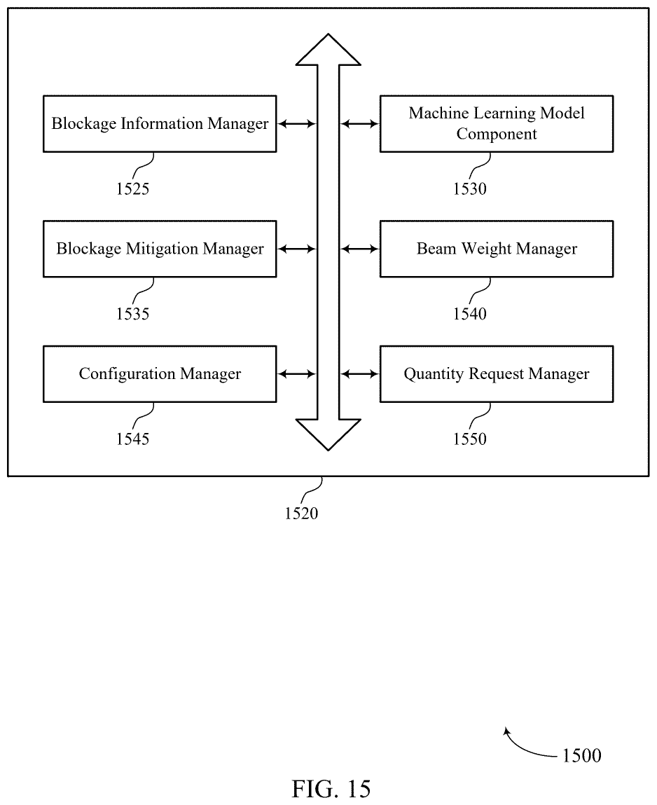

FIG. 15 shows a block diagram 1500 of a communications manager 1520 that supports machine learning blockage mitigation in accordance with one or more aspects of the present disclosure. The communications manager 1520 may be an example of aspects of a communications manager 1320, a communications manager 1420, or both, as described herein. The communications manager 1520, or various components thereof, may be an example of means for performing various aspects of machine learning blockage mitigation as described herein. For example, the communications manager 1520 may include a blockage information manager 1525, a machine learning model component 1530, a blockage mitigation manager 1535, a beam weight manager 1540, a configuration manager 1545, a quantity request manager 1550, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1520 may support wireless communications in accordance with examples as disclosed herein. The blockage information manager 1525 is capable of, configured to, or operable to support a means for obtaining first information that is indicative of a set of characteristics associated with a blockage of one or more antenna panels of a UE. The machine learning model component 1530 is capable of, configured to, or operable to support a means for using a machine learning model to obtain second information based on the first information. The blockage mitigation manager 1535 is capable of, configured to, or operable to support a means for outputting the second information based on usage of the machine learning model, the second information associated with mitigation of the blockage and indicative of one or more first sets of beam weights available to the UE. The beam weight manager 1540 is capable of, configured to, or operable to support a means for communicating in accordance with one or more second sets of beam weights derived from the one or more first sets of beam weights.

In some examples, the machine learning model component 1530 is capable of, configured to, or operable to support a means for obtaining, from one or more UEs prior to acquisition of the first information, third information for training the machine learning model, the third information indicative of a second set of characteristics associated with one or more second blockages of one or more second antenna panels of the one or more UEs, where usage of the machine learning model is based on the third information.

In some examples, the blockage is associated with a hand blockage or a body blockage. In some examples, the set of characteristics includes a grip strength of the hand blockage, a quantity of fingers that block the one or more antenna panels, a skin property of the hand blockage, a body tissue characteristic associated with the body blockage, or any combination thereof.

In some examples, the set of characteristics is associated with data from one or more sensors.

In some examples, the first information includes an indication of one or more third sets of beam weights associated with mitigation of the blockage.

In some examples, the configuration manager 1545 is capable of, configured to, or operable to support a means for outputting a control message including configuration information associated with one or more reporting occasions, where acquisition of the first information occurs within the one or more reporting occasions based on the configuration information.

In some examples, the first information is associated with input data for the machine learning model. In some examples, the second information is associated with an output that is inferred based on use of the machine learning model in accordance with the input data.

In some examples, to support outputting the second information, the blockage mitigation manager 1535 is capable of, configured to, or operable to support a means for outputting a first index associated with a first set of beam weights including the one or more first sets of beam weights, where the first index is one of a set of multiple indices that are each associated with a respective set of beam weights of a set of multiple sets of beam weights.

In some examples, the quantity request manager 1550 is capable of, configured to, or operable to support a means for obtaining, prior to output of the second information, an indication of a requested quantity of beam weights, where a quantity of beam weights of the one or more first sets of beam weights is based on the requested quantity.

In some examples, the one or more first sets of beam weights are associated with a set of multiple beam weights available to one or more UEs.

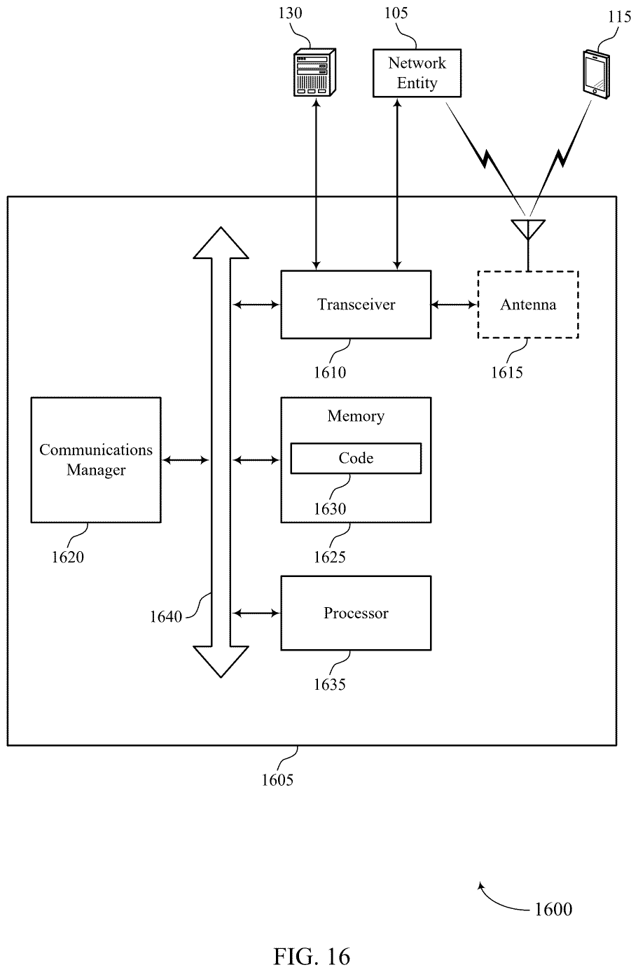

FIG. 16 shows a diagram of a system 1600 including a device 1605 that supports machine learning blockage mitigation in accordance with one or more aspects of the present disclosure. The device 1605 may be an example of or include components of a device 1305, a device 1405, or a network entity 105 as described herein. The device 1605 may communicate with other network devices or network equipment such as one or more of the network entities 105, UEs 115, or any combination thereof. The communications may include communications over one or more wired interfaces, over one or more wireless interfaces, or any combination thereof. The device 1605 may include components that support outputting and obtaining communications, such as a communications manager 1620, a transceiver 1610, one or more antennas 1615, at least one memory 1625, code 1630, and at least one processor 1635. These components may be in electronic communication or otherwise coupled (e.g., operatively, communicatively, functionally, electronically, electrically) via one or more buses (e.g., a bus 1640).

The transceiver 1610 may support bi-directional communications via wired links, wireless links, or both as described herein. In some examples, the transceiver 1610 may include a wired transceiver and may communicate bi-directionally with another wired transceiver. Additionally, or alternatively, in some examples, the transceiver 1610 may include a wireless transceiver and may communicate bi-directionally with another wireless transceiver. In some examples, the device 1605 may include one or more antennas 1615, which may be capable of transmitting or receiving wireless transmissions (e.g., concurrently). The transceiver 1610 may also include a modem to modulate signals, to provide the modulated signals for transmission (e.g., by one or more antennas 1615, by a wired transmitter), to receive modulated signals (e.g., from one or more antennas 1615, from a wired receiver), and to demodulate signals. In some implementations, the transceiver 1610 may include one or more interfaces, such as one or more interfaces coupled with the one or more antennas 1615 that are configured to support various receiving or obtaining operations, or one or more interfaces coupled with the one or more antennas 1615 that are configured to support various transmitting or outputting operations, or a combination thereof. In some implementations, the transceiver 1610 may include or be configured for coupling with one or more processors or one or more memory components that are operable to perform or support operations based on received or obtained information or signals, or to generate information or other signals for transmission or other outputting, or any combination thereof. In some implementations, the transceiver 1610, or the transceiver 1610 and the one or more antennas 1615, or the transceiver 1610 and the one or more antennas 1615 and one or more processors or one or more memory components (e.g., the at least one processor 1635, the at least one memory 1625, or both), may be included in a chip or chip assembly that is installed in the device 1605. In some examples, the transceiver 1610 may be operable to support communications via one or more communications links (e.g., communication link(s) 125, backhaul communication link(s) 120, a midhaul communication link 162, a fronthaul communication link 168).

The at least one memory 1625 may include RAM, ROM, or any combination thereof. The at least one memory 1625 may store computer-readable, computer-executable, or processor-executable code, such as the code 1630. The code 1630 may include instructions that, when executed by one or more of the at least one processor 1635, cause the device 1605 to perform various functions described herein. The code 1630 may be stored in a non-transitory computer-readable medium such as system memory or another type of memory. In some cases, the code 1630 may not be directly executable by a processor of the at least one processor 1635 but may cause a computer (e.g., when compiled and executed) to perform functions described herein. In some cases, the at least one memory 1625 may include, among other things, a BIOS which may control basic hardware or software operation such as the interaction with peripheral components or devices. In some examples, the at least one processor 1635 may include multiple processors and the at least one memory 1625 may include multiple memories. One or more of the multiple processors may be coupled with one or more of the multiple memories which may, individually or collectively, be configured to perform various functions herein (for example, as part of a processing system).

The at least one processor 1635 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1635 may be configured to operate a memory array using a memory controller. In some other cases, a memory controller may be integrated into one or more of the at least one processor 1635. The at least one processor 1635 may be configured to execute computer-readable instructions stored in a memory (e.g., one or more of the at least one memory 1625) to cause the device 1605 to perform various functions (e.g., functions or tasks supporting machine learning blockage mitigation). For example, the device 1605 or a component of the device 1605 may include at least one processor 1635 and at least one memory 1625 coupled with one or more of the at least one processor 1635, the at least one processor 1635 and the at least one memory 1625 configured to perform various functions described herein. The at least one processor 1635 may be an example of a cloud-computing platform (e.g., one or more physical nodes and supporting software such as operating systems, virtual machines, or container instances) that may host the functions (e.g., by executing code 1630) to perform the functions of the device 1605. The at least one processor 1635 may be any one or more suitable processors capable of executing scripts or instructions of one or more software programs stored in the device 1605 (such as within one or more of the at least one memory 1625).

In some examples, the at least one processor 1635 may include multiple processors and the at least one memory 1625 may include multiple memories. One or more of the multiple processors may be coupled with one or more of the multiple memories, which may, individually or collectively, be configured to perform various functions herein. In some examples, the at least one processor 1635 may be a component of a processing system, which may refer to a system (such as a series) of machines, circuitry (including, for example, one or both of processor circuitry (which may include the at least one processor 1635) and memory circuitry (which may include the at least one memory 1625)), or components, that receives or obtains inputs and processes the inputs to produce, generate, or obtain a set of outputs. The processing system may be configured to perform one or more of the functions described herein. For example, the at least one processor 1635 or a processing system including the at least one processor 1635 may be configured to, configurable to, or operable to cause the device 1605 to perform one or more of the functions described herein. Further, as described herein, being “configured to,” being “configurable to,” and being “operable to” may be used interchangeably and may be associated with a capability, when executing code stored in the at least one memory 1625 or otherwise, to perform one or more of the functions described herein.

In some examples, a bus 1640 may support communications of (e.g., within) a protocol layer of a protocol stack. In some examples, a bus 1640 may support communications associated with a logical channel of a protocol stack (e.g., between protocol layers of a protocol stack), which may include communications performed within a component of the device 1605, or between different components of the device 1605 that may be co-located or located in different locations (e.g., where the device 1605 may refer to a system in which one or more of the communications manager 1620, the transceiver 1610, the at least one memory 1625, the code 1630, and the at least one processor 1635 may be located in one of the different components or divided between different components).

In some examples, the communications manager 1620 may manage aspects of communications with a core network 130 (e.g., via one or more wired or wireless backhaul links). For example, the communications manager 1620 may manage the transfer of data communications for client devices, such as one or more UEs 115. In some examples, the communications manager 1620 may manage communications with one or more other network entities 105, and may include a controller or scheduler for controlling communications with UEs 115 (e.g., in cooperation with the one or more other network devices). In some examples, the communications manager 1620 may support an X2 interface within an LTE/LTE-A wireless communications network technology to provide communication between network entities 105.

The communications manager 1620 may support wireless communications in accordance with examples as disclosed herein. For example, the communications manager 1620 is capable of, configured to, or operable to support a means for obtaining first information that is indicative of a set of characteristics associated with a blockage of one or more antenna panels of a UE. The communications manager 1620 is capable of, configured to, or operable to support a means for using a machine learning model to obtain second information based on the first information. The communications manager 1620 is capable of, configured to, or operable to support a means for outputting the second information based on usage of the machine learning model, the second information associated with mitigation of the blockage and indicative of one or more first sets of beam weights available to the UE. The communications manager 1620 is capable of, configured to, or operable to support a means for communicating in accordance with one or more second sets of beam weights derived from the one or more first sets of beam weights.

By including or configuring the communications manager 1620 in accordance with examples as described herein, the device 1605 may support techniques for improved communication reliability, reduced latency, more efficient utilization of communication resources, improved coordination between devices, and improved utilization of processing capability, among other benefits.

In some examples, the communications manager 1620 may be configured to perform various operations (e.g., receiving, obtaining, monitoring, outputting, transmitting) using or otherwise in cooperation with the transceiver 1610, the one or more antennas 1615 (e.g., where applicable), or any combination thereof. Although the communications manager 1620 is illustrated as a separate component, in some examples, one or more functions described with reference to the communications manager 1620 may be supported by or performed by the transceiver 1610, one or more of the at least one processor 1635, one or more of the at least one memory 1625, the code 1630, or any combination thereof (for example, by a processing system including at least a portion of the at least one processor 1635, the at least one memory 1625, the code 1630, or any combination thereof). For example, the code 1630 may include instructions executable by one or more of the at least one processor 1635 to cause the device 1605 to perform various aspects of machine learning blockage mitigation as described herein, or the at least one processor 1635 and the at least one memory 1625 may be otherwise configured to, individually or collectively, perform or support such operations.

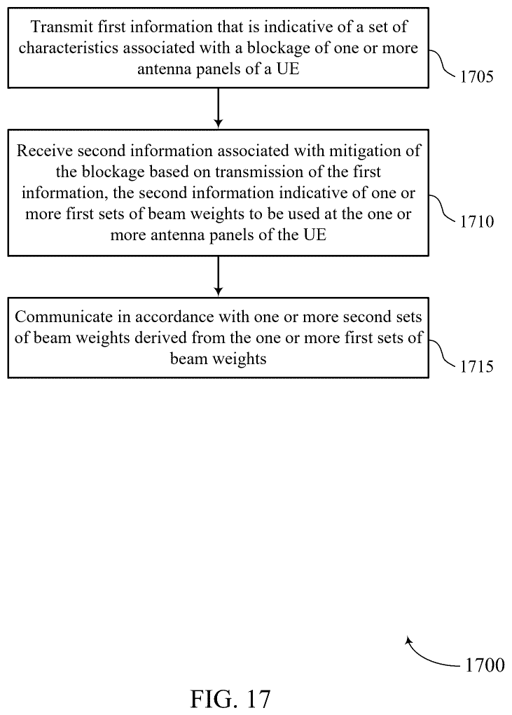

FIG. 17 shows a flowchart illustrating a method 1700 that supports machine learning blockage mitigation in accordance with one or more aspects of the present disclosure. The operations of the method 1700 may be implemented by a UE or its components as described herein. For example, the operations of the method 1700 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1705, the method may include transmitting first information that is indicative of a set of characteristics associated with a blockage of one or more antenna panels of a UE. The operations of 1705 may be performed in accordance with examples as disclosed herein. In some examples, aspects of the operations of 1705 may be performed by a blockage information component 1125 as described with reference to FIG. 11.

At 1710, the method may include receiving second information associated with mitigation of the blockage based on transmission of the first information, the second information indicative of one or more first sets of beam weights to be used at the one or more antenna panels of the UE. The operations of 1710 may be performed in accordance with examples as disclosed herein. In some examples, aspects of the operations of 1710 may be performed by a blockage mitigation component 1130 as described with reference to FIG. 11.

At 1715, the method may include communicating in accordance with one or more second sets of beam weights derived from the one or more first sets of beam weights. The operations of 1715 may be performed in accordance with examples as disclosed herein. In some examples, aspects of the operations of 1715 may be performed by a beam weight component 1135 as described with reference to FIG. 11.

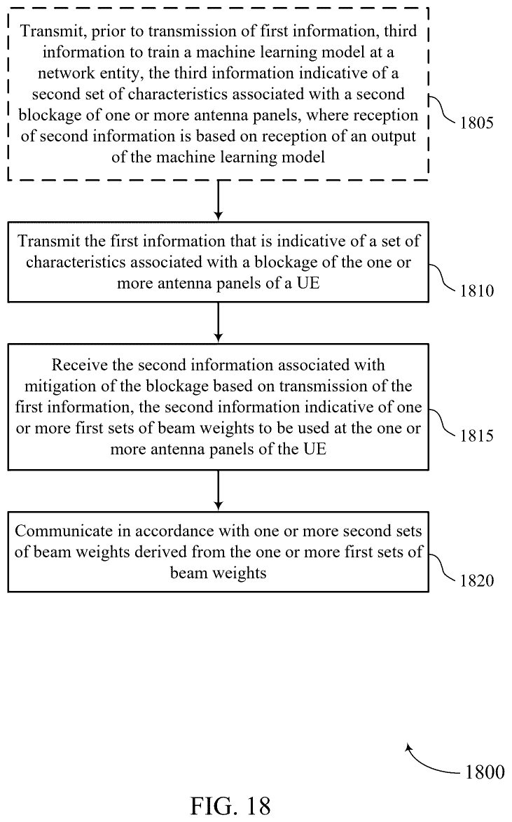

FIG. 18 shows a flowchart illustrating a method 1800 that supports machine learning blockage mitigation in accordance with one or more aspects of the present disclosure. The operations of the method 1800 may be implemented by a UE or its components as described herein. For example, the operations of the method 1800 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1805, in some examples, the method may include transmitting, prior to transmission of first information, third information to train a machine learning model at a network entity, the third information indicative of a second set of characteristics associated with a second blockage of one or more antenna panels, where reception of second information is based on reception of an output of the machine learning model. The operations of 1805 may be performed in accordance with examples as disclosed herein. In some examples, aspects of the operations of 1805 may be performed by a training data component 1140 as described with reference to FIG. 11.

At 1810, the method may include transmitting the first information that is indicative of a set of characteristics associated with a blockage of the one or more antenna panels of a UE. The operations of 1810 may be performed in accordance with examples as disclosed herein. In some examples, aspects of the operations of 1810 may be performed by a blockage information component 1125 as described with reference to FIG. 11.

At 1815, the method may include receiving the second information associated with mitigation of the blockage based on transmission of the first information, the second information indicative of one or more first sets of beam weights to be used at the one or more antenna panels of the UE. The operations of 1815 may be performed in accordance with examples as disclosed herein. In some examples, aspects of the operations of 1815 may be performed by a blockage mitigation component 1130 as described with reference to FIG. 11.

At 1820, the method may include communicating in accordance with one or more second sets of beam weights derived from the one or more first sets of beam weights. The operations of 1820 may be performed in accordance with examples as disclosed herein. In some examples, aspects of the operations of 1820 may be performed by a beam weight component 1135 as described with reference to FIG. 11.

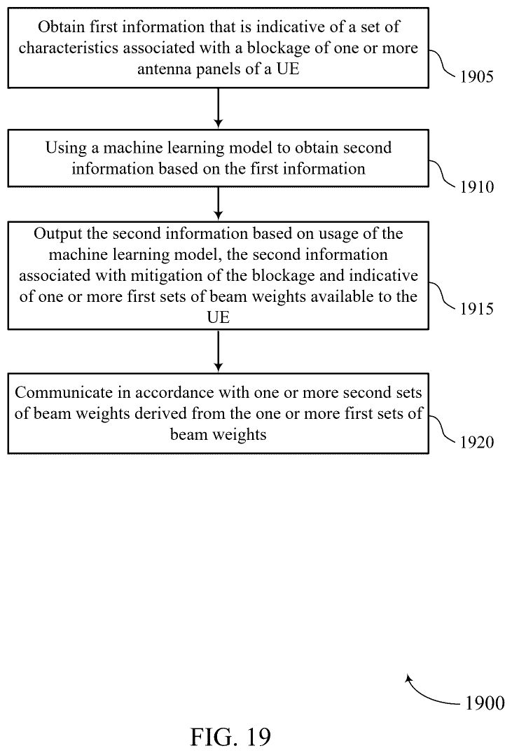

FIG. 19 shows a flowchart illustrating a method 1900 that supports machine learning blockage mitigation in accordance with one or more aspects of the present disclosure. The operations of the method 1900 may be implemented by a network entity or its components as described herein. For example, the operations of the method 1900 may be performed by a network entity as described with reference to FIGS. 1 through 5 and 13 through 16. In some examples, a network entity may execute a set of instructions to control the functional elements of the network entity to perform the described functions. Additionally, or alternatively, the network entity may perform aspects of the described functions using special-purpose hardware.

At 1905, the method may include obtaining first information that is indicative of a set of characteristics associated with a blockage of one or more antenna panels of a UE. The operations of 1905 may be performed in accordance with examples as disclosed herein. In some examples, aspects of the operations of 1905 may be performed by a blockage information manager 1525 as described with reference to FIG. 15.

At 1910, the method may include using a machine learning model to obtain second information based on the first information. The operations of 1910 may be performed in accordance with examples as disclosed herein. In some examples, aspects of the operations of 1910 may be performed by a machine learning model component 1530 as described with reference to FIG. 15.

At 1915, the method may include outputting the second information based on usage of the machine learning model, the second information associated with mitigation of the blockage and indicative of one or more first sets of beam weights available to the UE. The operations of 1915 may be performed in accordance with examples as disclosed herein. In some examples, aspects of the operations of 1915 may be performed by a blockage mitigation manager 1535 as described with reference to FIG. 15.

At 1920, the method may include communicating in accordance with one or more second sets of beam weights derived from the one or more first sets of beam weights. The operations of 1920 may be performed in accordance with examples as disclosed herein. In some examples, aspects of the operations of 1920 may be performed by a beam weight manager 1540 as described with reference to FIG. 15.

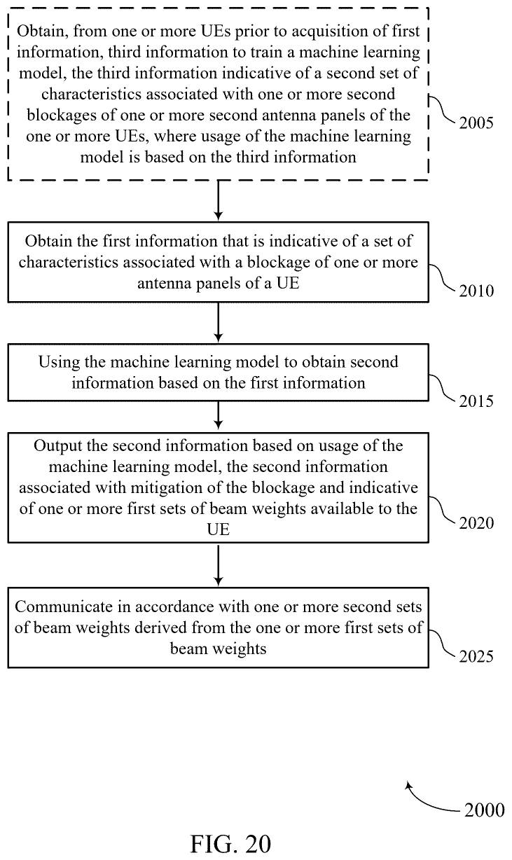

FIG. 20 shows a flowchart illustrating a method 2000 that supports machine learning blockage mitigation in accordance with one or more aspects of the present disclosure. The operations of the method 2000 may be implemented by a network entity or its components as described herein. For example, the operations of the method 2000 may be performed by a network entity as described with reference to FIGS. 1 through 5 and 13 through 16. In some examples, a network entity may execute a set of instructions to control the functional elements of the network entity to perform the described functions. Additionally, or alternatively, the network entity may perform aspects of the described functions using special-purpose hardware.

At 2005, in some examples, the method may include obtaining, from one or more UEs prior to acquisition of first information, third information to train a machine learning model, the third information indicative of a second set of characteristics associated with one or more second blockages of one or more second antenna panels of the one or more UEs, where usage of the machine learning model is based on the third information. The operations of 2005 may be performed in accordance with examples as disclosed herein. In some examples, aspects of the operations of 2005 may be performed by a machine learning model component 1530 as described with reference to FIG. 15.

At 2010, the method may include obtaining first information that is indicative of a set of characteristics associated with a blockage of one or more antenna panels of a UE. The operations of 2010 may be performed in accordance with examples as disclosed herein. In some examples, aspects of the operations of 2010 may be performed by a blockage information manager 1525 as described with reference to FIG. 15.

At 2015, the method may include using a machine learning model to obtain second information based on the first information. The operations of 2015 may be performed in accordance with examples as disclosed herein. In some examples, aspects of the operations of 2015 may be performed by a machine learning model component 1530 as described with reference to FIG. 15.

At 2020, the method may include outputting the second information based on usage of the machine learning model, the second information associated with mitigation of the blockage and indicative of one or more first sets of beam weights available to the UE. The operations of 2020 may be performed in accordance with examples as disclosed herein. In some examples, aspects of the operations of 2020 may be performed by a blockage mitigation manager 1535 as described with reference to FIG. 15.

At 2025, the method may include communicating in accordance with one or more second sets of beam weights derived from the one or more first sets of beam weights. The operations of 2025 may be performed in accordance with examples as disclosed herein. In some examples, aspects of the operations of 2025 may be performed by a beam weight manager 1540 as described with reference to FIG. 15.

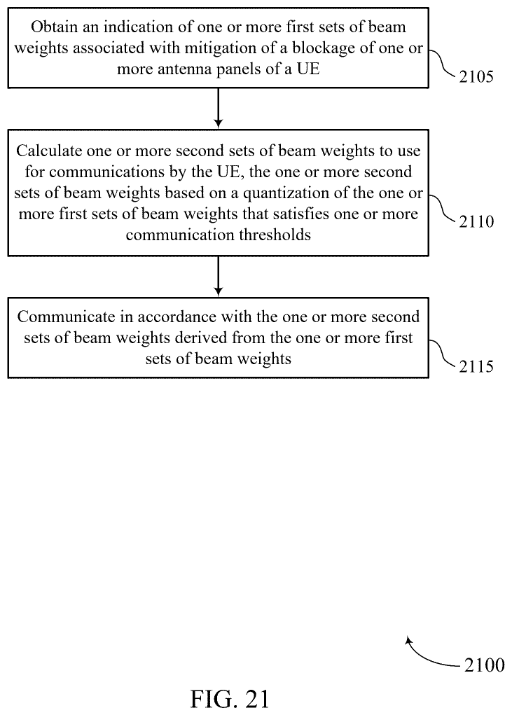

FIG. 21 shows a flowchart illustrating a method 2100 that supports machine learning blockage mitigation in accordance with one or more aspects of the present disclosure. The operations of the method 2100 may be implemented by a UE or its components as described herein. For example, the operations of the method 2100 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 2105, the method may include obtaining an indication of one or more first sets of beam weights associated with mitigation of a blockage of one or more antenna panels of a UE. The operations of 2105 may be performed in accordance with examples as disclosed herein. In some examples, aspects of the operations of 2105 may be performed by a blockage mitigation component 1130 as described with reference to FIG. 11.

At 2110, the method may include calculating one or more second sets of beam weights to use for communications by the UE, the one or more second sets of beam weights based on a quantization of the one or more first sets of beam weights that satisfies one or more communication thresholds. The operations of 2110 may be performed in accordance with examples as disclosed herein. In some examples, aspects of the operations of 2110 may be performed by a beam weight component 1135 as described with reference to FIG. 11.

At 2115, the method may include communicating in accordance with the one or more second sets of beam weights derived from the one or more first sets of beam weights. The operations of 2115 may be performed in accordance with examples as disclosed herein. In some examples, aspects of the operations of 2115 may be performed by a beam weight component 1135 as described with reference to FIG. 11.

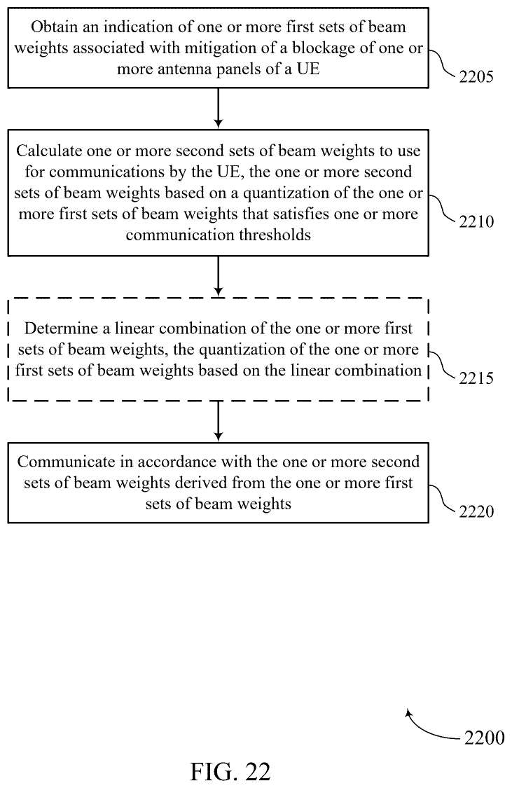

FIG. 22 shows a flowchart illustrating a method 2200 that supports machine learning blockage mitigation in accordance with one or more aspects of the present disclosure. The operations of the method 2200 may be implemented by a UE or its components as described herein. For example, the operations of the method 2200 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 2205, the method may include obtaining an indication of one or more first sets of beam weights associated with mitigation of a blockage of one or more antenna panels of a UE. The operations of 2205 may be performed in accordance with examples as disclosed herein. In some examples, aspects of the operations of 2205 may be performed by a blockage mitigation component 1130 as described with reference to FIG. 11.

At 2210, the method may include calculating one or more second sets of beam weights to use for communications by the UE, the one or more second sets of beam weights based on a quantization of the one or more first sets of beam weights that satisfies one or more communication thresholds. The operations of 2210 may be performed in accordance with examples as disclosed herein. In some examples, aspects of the operations of 2210 may be performed by a beam weight component 1135 as described with reference to FIG. 11.

At 2215, in some examples, the method may include determining a linear combination of the one or more first sets of beam weights, the quantization of the one or more first sets of beam weights based on the linear combination. The operations of 2215 may be performed in accordance with examples as disclosed herein. In some examples, aspects of the operations of 2215 may be performed by a beam weight component 1135 as described with reference to FIG. 11.

At 2220, the method may include communicating in accordance with the one or more second sets of beam weights derived from the one or more first sets of beam weights. The operations of 2220 may be performed in accordance with examples as disclosed herein. In some examples, aspects of the operations of 2220 may be performed by a beam weight component 1135 as described with reference to FIG. 11.

The following provides an overview of aspects of the present disclosure:

Aspect 1: An apparatus for wireless communication at a UE, comprising one or more memories, and one or more processors coupled with the one or more memories and configured to cause the UE to: transmit first information that is indicative of a set of characteristics associated with a blockage of one or more antenna panels of the UE; receive second information associated with mitigation of the blockage based at least in part on transmission of the first information, the second information indicative of one or more first sets of beam weights to be used at the one or more antenna panels of the UE; and communicate in accordance with one or more second sets of beam weights derived from the one or more first sets of beam weights.

Aspect 2: The apparatus of aspect 1, wherein the one or more processors are further configured to cause the UE to: transmit, prior to transmission of the first information, third information to train a machine learning model at a network entity, the third information indicative of a second set of characteristics associated with a second blockage of the one or more antenna panels, wherein reception of the second information is based at least in part on reception of an output of the machine learning model.

Aspect 3: The apparatus of any of aspects 1 through 2, wherein the blockage is associated with a hand blockage or a body blockage, and the set of characteristics comprises a grip strength of the hand blockage, a quantity of fingers that block the one or more antenna panels, a skin property of the hand blockage, a body tissue characteristic associated with the body blockage, or any combination thereof.

Aspect 4: The apparatus of any of aspects 1 through 3, wherein the one or more processors are further configured to cause the UE to: obtain the set of characteristics from one or more sensors associated with detection of the blockage at the one or more antenna panels, wherein the set of characteristics indicated via the first information is based at least in part on data obtained from the one or more sensors.

Aspect 5: The apparatus of any of aspects 1 through 4, wherein the first information comprises an indication of one or more third sets of beam weights associated with mitigation of the blockage.

Aspect 6: The apparatus of any of aspects 1 through 5, wherein the one or more processors are further configured to cause the UE to: receive a control message comprising configuration information associated with one or more reporting occasions, wherein transmission of the first information occurs within the one or more reporting occasions based at least in part on the configuration information.

Aspect 7: The apparatus of any of aspects 1 through 6, wherein the first information is associated with input data for a machine learning model at a network entity, and the second information is associated with an output of the machine learning model that is based at least in part on the input data.

Aspect 8: The apparatus of any of aspects 1 through 7, wherein to receive the second information comprises: receive a first index associated with a first set of beam weights of the one or more first sets of beam weights, wherein the first index is one of a plurality of indices that are each associated with a respective set of beam weights of the one or more first sets of beam weights.

Aspect 9: The apparatus of any of aspects 1 through 8, wherein the one or more processors are further configured to cause the UE to: transmit, prior to reception of the second information, an indication of a requested quantity of beam weights, wherein a quantity of beam weights of the one or more first sets of beam weights is based at least in part on the requested quantity.

Aspect 10: The apparatus of any of aspects 1 through 9, wherein the one or more processors are further configured to cause the UE to: select the one or more second sets of beam weights from a plurality of available beam weights, wherein the plurality of available beam weights is defined based at least in part on the one or more first sets of beam weights.

Aspect 11: An apparatus for wireless communications at a network entity, comprising one or more memories, and one or more processors coupled with the one or more memories and configured to cause the network entity to: obtain first information that is indicative of a set of characteristics associated with a blockage of one or more antenna panels of a UE; use a machine learning model to obtain second information based at least in part on the first information; output the second information based at least in part on usage of the machine learning model, the second information associated with mitigation of the blockage and indicative of one or more first sets of beam weights available to the UE; and communicate in accordance with one or more second sets of beam weights derived from the one or more first sets of beam weights.

Aspect 12: The apparatus of aspect 11, wherein the one or more processors are configured to cause the network entity to: obtain, from one or more UEs prior to acquisition of the first information, third information to train the machine learning model, the third information indicative of a second set of characteristics associated with one or more second blockages of one or more second antenna panels of the one or more UEs, wherein usage of the machine learning model is based at least in part on the third information.

Aspect 13: The apparatus of any of aspects 11 through 12, wherein the blockage is associated with a hand blockage or a body blockage, and the set of characteristics comprises a grip strength of the hand blockage, a quantity of fingers that block the one or more antenna panels, a skin property of the hand blockage, a body tissue characteristic associated with the body blockage, or any combination thereof.

Aspect 14: The apparatus of any of aspects 11 through 13, wherein the set of characteristics is associated with data from one or more sensors.

Aspect 15: The apparatus of any of aspects 11 through 14, wherein the first information comprises an indication of one or more third sets of beam weights associated with mitigation of the blockage.

Aspect 16: The apparatus of any of aspects 11 through 15, wherein the one or more processors are configured to cause the network entity to: output a control message comprising configuration information associated with one or more reporting occasions, wherein acquisition of the first information occurs within the one or more reporting occasions based at least in part on the configuration information.

Aspect 17: The apparatus of any of aspects 11 through 16, wherein the first information is associated with input data for the machine learning model, and the second information is associated with an output that is inferred based at least in part on use of the machine learning model in accordance with the input data.

Aspect 18: The apparatus of any of aspects 11 through 17, wherein to output the second information comprises: output a first index associated with a first set of beam weights comprising the one or more first sets of beam weights, wherein the first index is one of a plurality of indices that are each associated with a respective set of beam weights of a plurality of sets of beam weights.

Aspect 19: The apparatus of any of aspects 11 through 18, wherein the one or more processors are configured to cause the network entity to: obtain, prior to output of the second information, an indication of a requested quantity of beam weights, wherein a quantity of beam weights of the one or more first sets of beam weights is based at least in part on the requested quantity.

Aspect 20: The apparatus of any of aspects 11 through 19, wherein the one or more first sets of beam weights are associated with a plurality of beam weights available to one or more UEs.

Aspect 21: An apparatus for wireless communications at a UE, comprising one or more memories, and one or more processors coupled with the one or more memories and configured to cause the UE to: obtain an indication of one or more first sets of beam weights associated with mitigation of a blockage of one or more antenna panels of the UE; calculate one or more second sets of beam weights to use for communications by the UE, the one or more second sets of beam weights based at least in part on a quantization of the one or more first sets of beam weights that satisfies one or more communication thresholds; and communicate in accordance with the one or more second sets of beam weights derived from the one or more first sets of beam weights.

Aspect 22: The apparatus of aspect 21, wherein to calculate the one or more second sets of beam weights comprises: determine a linear combination of the one or more first sets of beam weights, the quantization of the one or more first sets of beam weights based at least in part on the linear combination.

Aspect 23: The apparatus of any of aspects 21 through 22, wherein to obtain the one or more first sets of beam weights comprises: obtain one or more third sets of beam weights that are inferred based at least in part on a machine learning model; and select the one or more first sets of beam weights from a plurality of available beam weights, wherein the plurality of available beam weights is defined based at least in part on the one or more third sets of beam weights.

Aspect 24: The apparatus of any of aspects 21 through 23, wherein the one or more processors are further configured to cause the UE to: transmit first information that is indicative of a set of characteristics associated with the blockage, the first information associated with input data for a machine learning model at a network entity, wherein the one or more first sets of beam weights are obtained based at least in part on second information received from an output of the machine learning model that is based at least in part on the input data.

Aspect 25: The apparatus of any of aspects 21 through 24, wherein the one or more communication thresholds comprise one or more phase shift thresholds, one or more amplitude thresholds, or both.

Aspect 26: The apparatus of any of aspects 21 through 25, wherein the one or more second sets of beam weights are different than the one or more first sets of beam weights.

Aspect 27: A method for wireless communications at a UE, comprising: transmitting first information that is indicative of a set of characteristics associated with a blockage of one or more antenna panels of the UE; receiving second information associated with mitigation of the blockage based at least in part on transmission of the first information, the second information indicative of one or more first sets of beam weights to be used at the one or more antenna panels of the UE; and communicating in accordance with one or more second sets of beam weights derived from the one or more first sets of beam weights.

Aspect 28: The method of aspect 27, further comprising: transmitting, prior to transmission of the first information, third information to train a machine learning model at a network entity, the third information indicative of a second set of characteristics associated with a second blockage of the one or more antenna panels, wherein reception of the second information is based at least in part on reception of an output of the machine learning model.

Aspect 29: The method of any of aspects 27 through 28, wherein the blockage is associated with a hand blockage or a body blockage, and the set of characteristics comprises a grip strength of the hand blockage, a quantity of fingers that block the one or more antenna panels, a skin property of the hand blockage, a body tissue characteristic associated with the body blockage, or any combination thereof.

Aspect 30: The method of any of aspects 27 through 29, further comprising: obtaining the set of characteristics from one or more sensors associated with detection of the blockage at the one or more antenna panels, wherein the set of characteristics indicated via the first information is based at least in part on data obtained from the one or more sensors.

Aspect 31: The method of any of aspects 27 through 30, wherein the first information comprises an indication of one or more third sets of beam weights associated with mitigation of the blockage.

Aspect 32: The method of any of aspects 27 through 31, further comprising: receiving a control message comprising configuration information associated with one or more reporting occasions, wherein transmission of the first information occurs within the one or more reporting occasions based at least in part on the configuration information.

Aspect 33: The method of any of aspects 27 through 32, wherein the first information is associated with input data for a machine learning model at a network entity, and the second information is associated with an output of the machine learning model that is based at least in part on the input data.

Aspect 34: The method of any of aspects 27 through 33, wherein receiving the second information comprises: receiving a first index associated with a first set of beam weights of the one or more first sets of beam weights, wherein the first index is one of a plurality of indices that are each associated with a respective set of beam weights of the one or more first sets of beam weights.

Aspect 35: The method of any of aspects 27 through 34, further comprising: transmitting, prior to reception of the second information, an indication of a requested quantity of beam weights, wherein a quantity of beam weights of the one or more first sets of beam weights is based at least in part on the requested quantity.

Aspect 36: The method of any of aspects 27 through 35, further comprising: selecting the one or more second sets of beam weights from a plurality of available beam weights, wherein the plurality of available beam weights is defined based at least in part on the one or more first sets of beam weights.

Aspect 37: A method for wireless communications at a network entity, comprising: obtaining first information that is indicative of a set of characteristics associated with a blockage of one or more antenna panels of a UE; using a machine learning model to obtain second information based at least in part on the first information; outputting the second information based at least in part on usage of the machine learning model, the second information associated with mitigation of the blockage and indicative of one or more first sets of beam weights available to the UE; and communicating in accordance with one or more second sets of beam weights derived from the one or more first sets of beam weights.

Aspect 38: The method of aspect 37, further comprising: obtaining, from one or more UEs prior to acquisition of the first information, third information to train the machine learning model, the third information indicative of a second set of characteristics associated with one or more second blockages of one or more second antenna panels of the one or more UEs, wherein usage of the machine learning model is based at least in part on the third information.

Aspect 39: The method of any of aspects 37 through 38, wherein the blockage is associated with a hand blockage or a body blockage, and the set of characteristics comprises a grip strength of the hand blockage, a quantity of fingers that block the one or more antenna panels, a skin property of the hand blockage, a body tissue characteristic associated with the body blockage, or any combination thereof.

Aspect 40: The method of any of aspects 37 through 39, wherein the set of characteristics is associated with data from one or more sensors.

Aspect 41: The method of any of aspects 37 through 40, wherein the first information comprises an indication of one or more third sets of beam weights associated with mitigation of the blockage.

Aspect 42: The method of any of aspects 37 through 41, further comprising: outputting a control message comprising configuration information associated with one or more reporting occasions, wherein acquisition of the first information occurs within the one or more reporting occasions based at least in part on the configuration information.

Aspect 43: The method of any of aspects 37 through 42, wherein the first information is associated with input data for the machine learning model, and the second information is associated with an output that is inferred based at least in part on use of the machine learning model in accordance with the input data.

Aspect 44: The method of any of aspects 37 through 43, wherein outputting the second information comprises: outputting a first index associated with a first set of beam weights comprising the one or more first sets of beam weights, wherein the first index is one of a plurality of indices that are each associated with a respective set of beam weights of a plurality of sets of beam weights.

Aspect 45: The method of any of aspects 37 through 44, further comprising: obtaining, prior to output of the second information, an indication of a requested quantity of beam weights, wherein a quantity of beam weights of the one or more first sets of beam weights is based at least in part on the requested quantity.

Aspect 46: The method of any of aspects 37 through 45, wherein the one or more first sets of beam weights are associated with a plurality of beam weights available to one or more UEs.

Aspect 47: A method for wireless communications at a UE, comprising: obtaining an indication of one or more first sets of beam weights associated with mitigation of a blockage of one or more antenna panels of the UE; calculating one or more second sets of beam weights to use for communications by the UE, the one or more second sets of beam weights based at least in part on a quantization of the one or more first sets of beam weights that satisfies one or more communication thresholds; and communicating in accordance with the one or more second sets of beam weights derived from the one or more first sets of beam weights.

Aspect 48: The method of aspect 47, wherein calculating the one or more second sets of beam weights comprises: determining a linear combination of the one or more first sets of beam weights, the quantization of the one or more first sets of beam weights based at least in part on the linear combination.

Aspect 49: The method of any of aspects 47 through 48, wherein obtaining the one or more first sets of beam weights comprises: obtaining one or more third sets of beam weights that are inferred based at least in part on a machine learning model; and selecting the one or more first sets of beam weights from a plurality of available beam weights, wherein the plurality of available beam weights is defined based at least in part on the one or more third sets of beam weights.

Aspect 50: The method of any of aspects 47 through 49, further comprising: transmitting first information that is indicative of a set of characteristics associated with the blockage, the first information associated with input data for a machine learning model at a network entity, wherein the one or more first sets of beam weights are obtained based at least in part on second information received from an output of the machine learning model that is based at least in part on the input data.

Aspect 51: The method of any of aspects 47 through 50, wherein the one or more communication thresholds comprise one or more phase shift thresholds, one or more amplitude thresholds, or both.

Aspect 52: The method of any of aspects 47 through 51, wherein the one or more second sets of beam weights are different than the one or more first sets of beam weights.

Aspect 53: A UE for wireless communications, comprising at least one means for performing a method of any of aspects 27 through 36.

Aspect 54: A non-transitory computer-readable medium storing code for wireless communications, the code comprising instructions executable by one or more processors to perform a method of any of aspects 27 through 36.

Aspect 55: A network entity for wireless communications, comprising at least one means for performing a method of any of aspects 37 through 46.

Aspect 56: A non-transitory computer-readable medium storing code for wireless communications, the code comprising instructions executable by one or more processors to perform a method of any of aspects 37 through 46.

Aspect 57: A UE for wireless communications, comprising at least one means for performing a method of any of aspects 47 through 52.

Aspect 58: A non-transitory computer-readable medium storing code for wireless communications, the code comprising instructions executable by one or more processors to perform a method of any of aspects 47 through 52.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, the phrase “associated with” may refer to a relationship, a connection, or interaction between two or more elements, components, or entities, whether directly or indirectly. This relationship may include physical, functional, operational, or logical connections by which the elements, components, or entities work together, communicate, or have an effect on one another as described herein.

As used herein, including in the claims, the term “use” may refer to an application, employment, utilization of the subject matter in a manner that achieves a functional outcome, purpose, or result. For example, “using an ML model” may refer to any manner in which the ML model is applied, utilized, or engaged to achieve one or more functional outcomes, objectives, or practical results. Such reference may include, but is not limited to, training the model with data, utilizing the model in decision-making processes, and any other form of leveraging the model's capabilities and properties to obtain an output.

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a user equipment (UE), comprising:
one or more memories; and
one or more processors coupled with the one or more memories and configured to cause the UE to:
transmit first information that is indicative of a set of characteristics associated with a blockage of one or more antenna panels of the UE;
receive second information associated with mitigation of the blockage based at least in part on transmission of the first information, the second information indicative of one or more first sets of beam weights to be used at the one or more antenna panels of the UE; and
communicate in accordance with one or more second sets of beam weights derived from the one or more first sets of beam weights.

2. The UE of claim 1, wherein the one or more processors are further configured to cause the UE to:
transmit, prior to transmission of the first information, third information to train a machine learning model at a network entity, the third information indicative of a second set of characteristics associated with a second blockage of the one or more antenna panels, wherein reception of the second information is based at least in part on reception of an output of the machine learning model.

3. The UE of claim 1, wherein:
the blockage is associated with a hand blockage or a body blockage, and
the set of characteristics comprises a grip strength of the hand blockage, a quantity of fingers that block the one or more antenna panels, a skin property of the hand blockage, a body tissue characteristic associated with the body blockage, or any combination thereof.

4. The UE of claim 1, wherein the one or more processors are further configured to cause the UE to:
obtain the set of characteristics from one or more sensors associated with detection of the blockage at the one or more antenna panels, wherein the set of characteristics indicated via the first information is based at least in part on data obtained from the one or more sensors.

5. The UE of claim 1, wherein the first information comprises an indication of one or more third sets of beam weights associated with mitigation of the blockage.

6. The UE of claim 1, wherein the one or more processors are further configured to cause the UE to:
receive a control message comprising configuration information associated with one or more reporting occasions, wherein transmission of the first information occurs within the one or more reporting occasions based at least in part on the configuration information.

7. The UE of claim 1, wherein:
the first information is associated with input data for a machine learning model at a network entity, and
the second information is associated with an output of the machine learning model that is based at least in part on the input data.

8. The UE of claim 1, wherein, to receive the second information, the one or more processors are configured to cause the UE to:
receive a first index associated with a first set of beam weights of the one or more first sets of beam weights, wherein the first index is one of a plurality of indices that are each associated with a respective set of beam weights of the one or more first sets of beam weights.

9. The UE of claim 1, wherein the one or more processors are further configured to cause the UE to:
transmit, prior to reception of the second information, an indication of a requested quantity of beam weights, wherein a quantity of beam weights of the one or more first sets of beam weights is based at least in part on the requested quantity.

10. The UE of claim 1, wherein the one or more processors are further configured to cause the UE to:
select the one or more second sets of beam weights from a plurality of available beam weights, wherein the plurality of available beam weights is defined based at least in part on the one or more first sets of beam weights.

11. An apparatus for wireless communication at a network entity, comprising:
one or more memories; and
one or more processors coupled with the one or more memories and configured to cause the network entity to:
obtain first information that is indicative of a set of characteristics associated with a blockage of one or more antenna panels of a user equipment (UE);
use a machine learning model to obtain second information based at least in part on the first information;
output the second information based at least in part on usage of the machine learning model, the second information associated with mitigation of the blockage and indicative of one or more first sets of beam weights available to the UE; and
communicate in accordance with one or more second sets of beam weights derived from the one or more first sets of beam weights.

12. The network entity of claim 11, wherein the one or more processors are configured to cause the network entity to:
obtain, from one or more UEs prior to acquisition of the first information, third information to train the machine learning model, the third information indicative of a second set of characteristics associated with one or more second blockages of one or more second antenna panels of the one or more UEs, wherein usage of the machine learning model is based at least in part on the third information.

13. The network entity of claim 11, wherein:
the blockage is associated with a hand blockage or a body blockage, and
the set of characteristics comprises a grip strength of the hand blockage, a quantity of fingers that block the one or more antenna panels, a skin property of the hand blockage, a body tissue characteristic associated with the body blockage, or any combination thereof.

14. The network entity of claim 11, wherein:
the set of characteristics is associated with data from one or more sensors.

15. The network entity of claim 11, wherein the first information comprises an indication of one or more third sets of beam weights associated with mitigation of the blockage.

16. The network entity of claim 11, wherein the one or more processors are configured to cause the network entity to:
output a control message comprising configuration information associated with one or more reporting occasions, wherein acquisition of the first information occurs within the one or more reporting occasions based at least in part on the configuration information.

17. The network entity of claim 11, wherein:
the first information is associated with input data for the machine learning model, and
the second information is associated with an output that is inferred based at least in part on use of the machine learning model in accordance with the input data.

18. The network entity of claim 11, wherein, to output the second information, the one or more processors are configured to cause the network entity to:
output a first index associated with a first set of beam weights comprising the one or more first sets of beam weights, wherein the first index is one of a plurality of indices that are each associated with a respective set of beam weights of a plurality of sets of beam weights.

19. The network entity of claim 11, wherein the one or more processors are configured to cause the network entity to:
obtain, prior to output of the second information, an indication of a requested quantity of beam weights, wherein a quantity of beam weights of the one or more first sets of beam weights is based at least in part on the requested quantity.

20. The network entity of claim 11, wherein the one or more first sets of beam weights are associated with a plurality of beam weights available to one or more UEs.

21. An apparatus for wireless communication at a user equipment (UE), comprising:
one or more memories; and
one or more processors coupled with the one or more memories and configured to cause the UE to:
obtain an indication of one or more first sets of beam weights associated with mitigation of a blockage of one or more antenna panels of the UE;
calculate one or more second sets of beam weights to use for communications by the UE, the one or more second sets of beam weights based at least in part on a quantization of the one or more first sets of beam weights that satisfies one or more communication thresholds; and
communicate in accordance with the one or more second sets of beam weights derived from the one or more first sets of beam weights.

22. The UE of claim 21, wherein, to calculate the one or more second sets of beam weights, the one or more processors are configured to cause the UE to:
determine a linear combination of the one or more first sets of beam weights, the quantization of the one or more first sets of beam weights based at least in part on the linear combination.

23. The UE of claim 21, wherein, to obtain the one or more first sets of beam weights, the one or more processors are configured to cause the UE to:
obtain one or more third sets of beam weights that are inferred based at least in part on a machine learning model; and
select the one or more first sets of beam weights from a plurality of available beam weights, wherein the plurality of available beam weights is defined based at least in part on the one or more third sets of beam weights.

24. The UE of claim 21, wherein the one or more processors are further configured to cause the UE to:
transmit first information that is indicative of a set of characteristics associated with the blockage, the first information associated with input data for a machine learning model at a network entity, wherein the one or more first sets of beam weights are obtained based at least in part on second information received from an output of the machine learning model that is based at least in part on the input data.

25. The UE of claim 21, wherein the one or more communication thresholds comprise one or more phase shift thresholds, one or more amplitude thresholds, or both.

26. The UE of claim 21, wherein the one or more second sets of beam weights are different than the one or more first sets of beam weights.

27. A method for wireless communications at a user equipment (UE), comprising:
transmitting first information that is indicative of a set of characteristics associated with a blockage of one or more antenna panels of the UE;
receiving second information associated with mitigation of the blockage based at least in part on transmission of the first information, the second information indicative of one or more first sets of beam weights to be used at the one or more antenna panels of the UE; and
communicating in accordance with one or more second sets of beam weights derived from the one or more first sets of beam weights.

28. The method of claim 27, further comprising:
transmitting, prior to transmission of the first information, third information for training a machine learning model at a network entity, the third information indicative of a second set of characteristics associated with a second blockage of the one or more antenna panels, wherein reception of the second information is based at least in part on reception of an output of the machine learning model.

29. The method of claim 27, wherein:
the blockage is associated with a hand blockage or a body blockage, and
the set of characteristics comprises a grip strength of the hand blockage, a quantity of fingers that block the one or more antenna panels, a skin property of the hand blockage, a body tissue characteristic associated with the body blockage, or any combination thereof.

30. The method of claim 27, further comprising:
obtaining the set of characteristics from one or more sensors associated with detection of the blockage at the one or more antenna panels, wherein the set of characteristics indicated via the first information is based at least in part on data obtained from the one or more sensors.
